(19) United States
(12) Patent Application Publication
(10) Pub. No.: US 2024/0359624 A1
(43) Pub. Date: Oct. 31, 2024

(54) MITIGATION OF ACCIDENTS DUE TO GLARE FROM SUN OR HEADLIGHTS

(71) Applicant: Volvo Car Corporation, Gothenburg (SE)

(72) Inventors: Oswaldo Perez Barrera, Gothenburg (SE); Anders Lennartsson, Gothenburg (SE)

(21) Appl. No.: 18/306,522

(22) Filed: Apr. 25, 2023

(51) Int. Cl. B60Q 9/00; B60Q 1/50; B60Q 1/04

(52) U.S. Cl. CPC B60Q 9/008; B60Q 1/50; B60Q 1/04; B60Q 2300/23; B60Q 2300/42; B60Q 2800/10

(57) ABSTRACT

Various systems and methods are presented regarding utilizing technology onboard a first vehicle to mitigate road traffic accidents involving a second vehicle where the driver is affected by glare. Glare can be due to sunlight or headlight beams incident upon a driver's face. Glare can impede a driver's vision and ability to resolve a road or objects ahead. The first vehicle can detect the driver of the second vehicle may be impeded by glare, whereby, in response thereto, the first vehicle can (i) autonomously adjust operation of the first vehicle to reduce likelihood of involvement in accident with the second vehicle, (ii) can communicate with the second vehicle to beneficially affect operation of the second vehicle, and/or (iii) alert other entities using the road to presence of the first vehicle or second vehicle.

### TECHNICAL FIELD

This application relates to techniques facilitating operation of a vehicle to mitigate accidents resulting from a bright light as glare from sunlight or headlights.

### BACKGROUND

Temporary blindness arising from sun glare or headlights can give rise to, at best, driver discomfort, through to being a cause of accidents. Owing to the physiology of the human eyeball, transitions between bright light and shadows/darkness can cause a delay in the ability of the eye to resolve one or more objects in a field of view and further, the bright light may overly saturate the retina/photoreceptors to the point that the eyeball is unable to discern any objects within the field of vision. Devices such as sun-visors and sunglasses assist a driver in reducing the effects of sun glare, however, given the variability of the position of the sun relative to the vehicle/driver, such devices cannot be guaranteed to provide comprehensive reduction. Further, such devices are not suitable for evening/nighttime use where a driver may be faced with various light sources, including those from oncoming vehicles having headlights at low beam or full beam. Hence, driver operation of a vehicle while experiencing glare can give rise to an accident. For example, a driver makes a turn while experiencing sun glare, only to turn into the path of one or more cyclists.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented to facilitate a reduction in road traffic accidents by utilizing one or more systems/technologies located onboard a first vehicle to prevent accidents from glare effects occurring at a second vehicle and/or other entities.

According to one or more embodiments, a system is provided to mitigate collisions between vehicles and pedestrians. The system can be located on a first vehicle, wherein the first vehicle can be operating autonomously (e.g., as an autonomous vehicle (AV)). The system can comprise a memory that stores computer executable components and a processor that executes the computer executable components stored in the memory. The computer executable components can comprise an accident avoidance component that can be configured to adjust operation of the first vehicle based on an entity potentially being affected by glare. For example, the accident avoidance component can be configured to determine whether an entity, present on a road being navigated by the first vehicle, is potentially affected by glare, and further, in response to determining that the entity is potentially affected by glare, adjusting operation of the first vehicle to mitigate an effect of the entity being affected by the glare. In an embodiment, the glare is caused by sunlight, headlight beams, or a bright light being incident upon the entity. In an embodiment, the entity can be a driver operating a second vehicle, with the operation of the first vehicle being adjusted to prevent the second vehicle from colliding with at least one of the first vehicle or another entity present on the road. The adjusted operation of the first vehicle can further include at least one of reduce velocity of the first vehicle, stop the first vehicle, increase velocity of the first vehicle, generate an audible alarm at the first vehicle, or change operation from current road lane to an adjacent road lane. The entity can also be a pedestrian, a cyclist, or an animal, respectively located on or proximate to the road.

In another embodiment, the computer executable components can further comprise a vehicle detection component that can be configured to determine whether a second vehicle is being operated non-autonomously, partially autonomously, or fully autonomously. In response to determining the second vehicle is being operated non-autonomously or partially autonomously, the vehicle detection component can be further configured to generate an instruction to monitor operation of the second vehicle, and transmit the instruction to the accident avoidance component. In response to determining the second vehicle is being operated autonomously, the vehicle detection component can be further configured to generate an instruction to cease monitoring operation of the second vehicle, and transmit the instruction to the accident avoidance component.

In a further embodiment, the computer executable components can further comprise at least one camera configured to generate an image of the second vehicle. The vehicle detection component can be further configured to identify a manufacturer and model of the second vehicle depicted in the image, and/or access a vehicle database to determine whether the model of the second vehicle depicted in the image supports any of non-autonomous, partially autonomous, or fully autonomous operation.

In another embodiment, the computer executable components can further comprise a first communication system located onboard the first vehicle configured to communicate with a second communication system located onboard the second vehicle, and further generate and transmit an instruction to the second communication system, wherein the instruction requests the second vehicle to identify whether the second vehicle is being operated in non-autonomous, partially autonomous, or fully autonomous manner.

In another embodiment, the computer executable components can further comprise a vision component configured to, in the event of the entity is the driver of a second vehicle, determine the entity is, at least one of, wearing sunglasses, shielding their eyes with an onboard sun-visor, squinting, blinking in an erratic manner, blinking quickly, averting their gaze from sunlight, averting their gaze from a headlight beam, or is driving in an unaffected manner. The vision component can be further configured to, in response to determining the driver of the second vehicle is affected by glare, generate and transmit an instruction to the accident avoidance component instructing the accident avoidance component to maintain monitoring of the driver of the second vehicle. The vision component can be further configured to, in response to determining the driver of the second vehicle is not affected by glare, generate and transmit an instruction to the accident avoidance component instructing the accident avoidance component to discontinue monitoring of the driver of the second vehicle.

In a further embodiment, the computer executable components can further comprise an entity component configured to detect the presence of the entity in the road being navigated by the first vehicle, and further transmit a notification of the detected presence of the entity to the accident avoidance component. The accident avoidance component can be further configured to, in response to receiving the detected presence of the entity, instruct an audible device to generate an audible signal to obtain the entity's attention regarding the presence of at least one of the first vehicle or a second vehicle, and/or adjust operation of the first vehicle comprising at least one of change lane of operation of the first vehicle from a first lane to an adjacent lane or reduce velocity of the first vehicle.

In other embodiments, elements described in connection with the disclosed systems can be embodied in different forms such as computer-implemented methods, computer program products, or other forms. For example, in an embodiment, a computer-implemented method can be utilized for adjusting, by a device comprising a processor located on a first vehicle operating in a fully autonomous manner, operation of the first vehicle based on determining an entity is potentially being affected by glare, wherein operation of the first vehicle is adjusted to reduce probability of the entity being involved in an accident as a result of the glare, wherein the glare can result from sunlight, headlight beams, a bright light, and suchlike.

The entity can be one of a driver operating a second vehicle, a pedestrian, a cyclist, or an animal. The computer-implemented method can further comprise adjusting operation of the first vehicle to prevent the second vehicle from colliding with at least one of the first vehicle or another other entity present on the road or prevent the first vehicle from colliding with at least one of the second vehicle or another entity present on the road. The adjusted operation of the first vehicle can be at least one of reduce velocity of the first vehicle, stop the first vehicle, increase velocity of the first vehicle, generate an audible alarm at the first vehicle, or change operation from current road lane to an adjacent road lane.

In the event of the entity is a second vehicle, the first vehicle can be further configured to determine whether the second vehicle is being operated non-autonomously, partially autonomously, or fully autonomously. In response to determining the second vehicle is being operated non-autonomously or partially autonomously, the first vehicle can be further configured to maintain monitoring of the second vehicle. In response to determining the second vehicle is being operated autonomously, the first vehicle can be further configured to cease monitoring operation of the second vehicle.

In another embodiment, a computer program product comprising a computer readable storage medium having program instructions embodied therewith, the program instructions executable by a processor, can cause the processor to (i) detect, by a first vehicle operating in a fully autonomous manner, an entity present on a road being navigated by the first vehicle is potentially affected by glare, (ii) determine whether the entity is being affected by glare, and (iii) in response to determining that the entity is potentially affected by glare, adjust operation of the first vehicle to reduce probability of the entity being involved in an accident arising from the entity being affected by the glare. In an embodiment, the program instructions can cause the processor to adjust operation of a first vehicle in response to detecting an entity being potentially affected by glare, wherein the operation of the first vehicle is adjusted to reduce probability of the entity being involved in an accident as a result of the glare effect.

In an embodiment, the program instructions can further cause the processor to, in the event of the entity is one of a driver operating a second vehicle, a pedestrian, a cyclist, or an animal, adjust the operation of the first vehicle to (i) prevent the second vehicle from colliding with at least one of the first vehicle or another other entity present on the road, or (ii) prevent the first vehicle from colliding with at least one of the second vehicle or another entity present on the road.

In an embodiment, first vehicle can be operated in one of an autonomous, a partially autonomous, or a non-autonomous manner and the second vehicle can be operated in one of an autonomous, a partially autonomous, or a non-autonomous manner.

An advantage of the one or more systems, computer-implemented methods and/or computer program products can be utilizing various systems and technologies located on a first vehicle to detect the presence of an entity, and further monitor the entity's susceptibility to glare, to reduce the probability that the entity will be involved in an accident as a result of the glare effect.

### DESCRIPTION OF THE DRAWINGS

One or more embodiments are described below in the Detailed Description section with reference to the following drawings.

FIG. 1A presents a system that can be utilized onboard a vehicle to reduce traffic accidents between vehicles and pedestrians, in accordance with one or more embodiments

FIG. 1B illustrates a system that can be utilized onboard a vehicle to reduce traffic accidents between vehicles and pedestrians, in accordance with one or more embodiments.

FIGS. 2A and 2B present schematics illustrating respective positions of a sun and/or a light source regarding glaring occurring, in accordance with one or more embodiments.

FIG. 3 presents a schematic illustrating various operating conditions that may be present during operation of a vehicle, in accordance with at least one embodiment.

FIG. 4 presents a schematic illustrating various vehicles, wherein at least one of the vehicles is configured to determine operation of the other vehicles, in accordance with an embodiment.

FIGS. 5A-C are schematics presenting operations/actions that can be performed by a vehicle in response to respective scenarios, in accordance with one or more embodiments.

FIGS. 6A-C are schematics presenting a scenario of operation of an autonomous vehicle responsive to operation of a second vehicle, in accordance with one or more embodiments.

FIG. 7 is a schematic illustrating a scenario of operation of an autonomous vehicle responsive to operation of a second vehicle, in accordance with one or more embodiments.

FIG. 8 is a schematic presenting a scenario of a first vehicle operating to avoid an accident between a second vehicle and a pedestrian, in accordance with one or more embodiments.

FIG. 9 is a schematic presenting a scenario of a vehicle operating to avoid an accident with a cyclist, in accordance with one or more embodiments.

FIG. 10 is a schematic illustrating a scenario of a vehicle operating to avoid an accident with a cyclist, in accordance with one or more embodiments.

FIG. 11 is a schematic presenting a scenario of a vehicle operating to avoid an accident with a pedestrian, in accordance with one or more embodiments.

FIG. 12 is a schematic illustrating a scenario of a first vehicle operating and communicating with a second vehicle to prevent the second vehicle from colliding with a third vehicle, in accordance with one or more embodiments.

FIG. 13, images 1300A-E present concepts relating to headlight beam detection and determination, according to one or more embodiments.

FIG. 14, is a chart illustrating a pixel extraction process being undertaken, in accordance with an embodiment.

FIG. 15 is a schematic illustrating light analysis being performed to determine whether a light source is stationary or moving, in accordance with an embodiment.

FIG. 16 is a schematic presenting an example scenario of a first vehicle operating to prevent an accident involving a second vehicle, according to one or more embodiments.

FIG. 17 is a schematic presenting an example scenario of a first vehicle operating to prevent an accident involving a second vehicle, according to one or more embodiments.

FIG. 18 is a schematic presenting an example scenario of a first vehicle operating to prevent being involved in an accident involving a second vehicle, according to one or more embodiments.

FIG. 19 is a schematic presenting an example scenario of a first vehicle operating to prevent being involved in an accident involving a second vehicle, according to one or more embodiments.

FIGS. 20A-C illustrate various example scenarios regarding determination of whether a driver is affected by glare, in accordance with one or more embodiments.

FIG. 21 illustrates a flow diagram for a computer-implemented methodology for a first vehicle preventing an accident involving a second vehicle and/or another entity, in accordance with at least one embodiment.

FIG. 22 illustrates a flow diagram for a computer-implemented methodology for a first vehicle preventing an accident involving an entity located on or by a road, in accordance with at least one embodiment.

FIG. 23 is a block diagram illustrating an example computing environment in which the various embodiments described herein can be implemented.

FIG. 24 is a block diagram illustrating an example computing environment with which the disclosed subject matter can interact, in accordance with an embodiment.

FIG. 25 presents TABLE 2500 presenting a summary of SAE J3016 detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to utilizing one or more components located on a vehicle (e.g., while being operated in an autonomous manner) to prevent an accident arising due to an effect(s) of glare. One or more components located on the vehicle (e.g., a first vehicle) can be configured to determine whether (a) glare effects exist (e.g., sunlight, headlight beams, a bright light), (b) whether an entity (e.g., a driver of a second vehicle, a pedestrian, a cyclist, a runner, an animal) is affected by the glare effect, and (c) actions to take by the vehicle to mitigate the effects of the glare effect, e.g., to prevent an accident occurring between any of the first vehicle, a second vehicle, or another entity.

In an embodiment, the first vehicle can determine whether the second vehicle is being operated partially autonomously or non-autonomously, and in the event of that being the case, the first vehicle can monitor the driver of the second vehicle to determine whether the driver is affected by glare. While driving under the effects of glare, the driver of the second vehicle may not be aware of the presence of the first vehicle, or other entities on or near the road, and accordingly, the second vehicle may be involved in an accident with the first vehicle and/or the other entities. Various components, sensors, etc., can be utilized on the first vehicle to minimize the possibility of the second vehicle being involved in an accident.

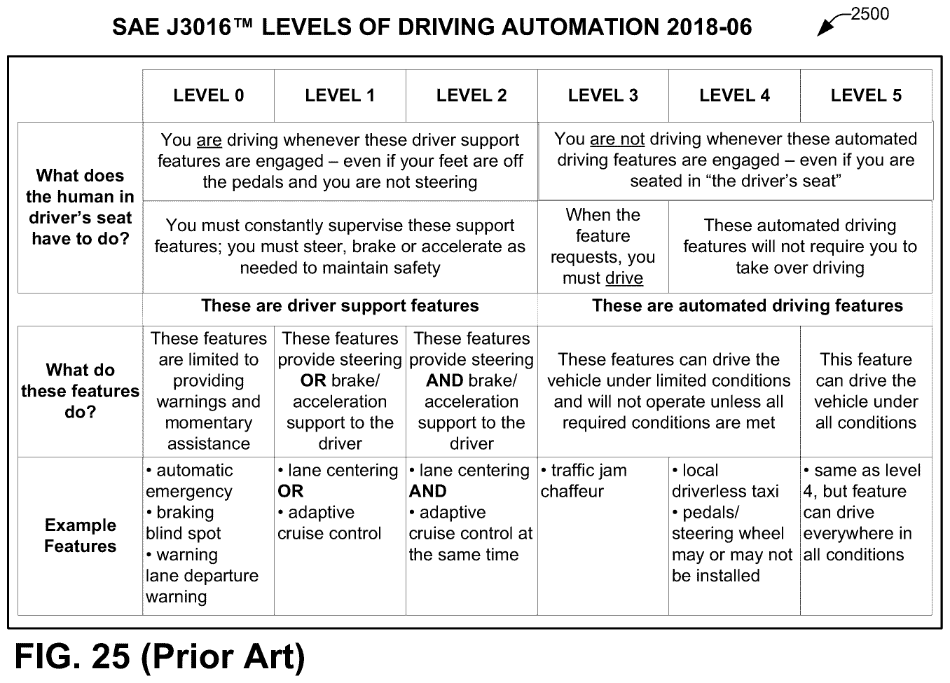

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 25, Table 2500.
Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.
Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.
Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.
Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.
Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.
Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner (e.g., as an AV), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle can be operating in an autonomous manner (e.g., any of Levels 3-5), a partially autonomous manner (e.g., any of levels 1-2), or in a non-autonomous manner (e.g., Level 0), while a second vehicle (e.g., vehicle 105) can also be operating in any of an autonomous manner, a partially autonomous manner, or in a non-autonomous manner.

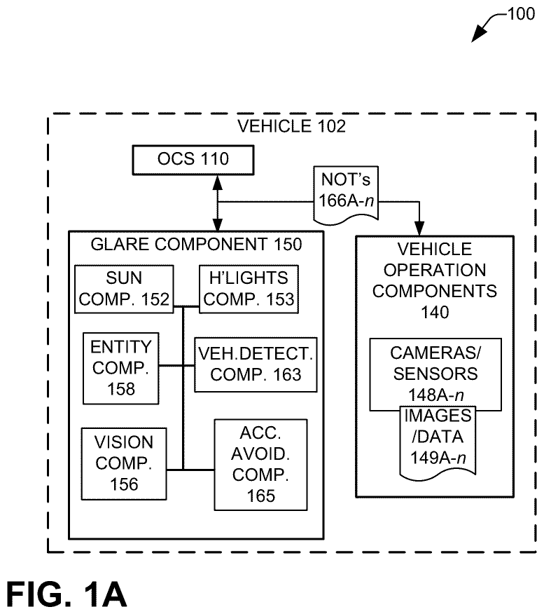

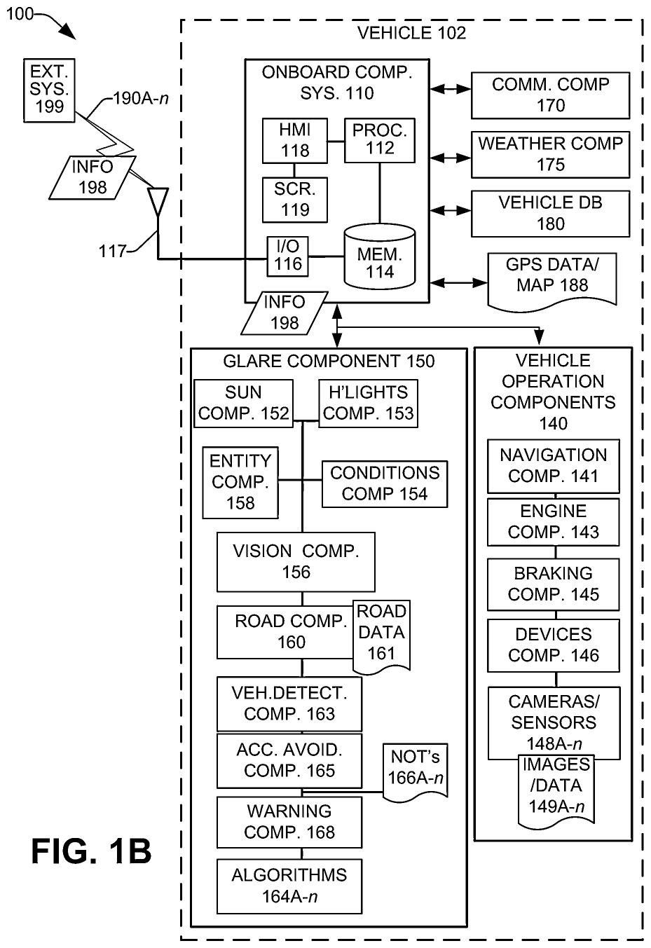

Turning now to the drawings, FIG. 1A presents a system overview 100 that can be utilized by a vehicle to reduce traffic accidents between vehicles and pedestrians, in accordance with one or more embodiments. System 100 comprises a vehicle 102 with various devices and components located thereon, such as an onboard computer system (OCS) 110, wherein the OCS 110 can be a vehicle control unit (VCU). The OCS 110 can be utilized to provide overall operational control and/or operation of vehicle 102. In an embodiment, the OCS 110 can be configured to operate/control/monitor various vehicle operations, wherein the various operations can be controlled by one or more vehicle operation components 140 communicatively coupled to the OCS 110. Such operations can include increasing/reducing velocity of vehicle 102, stopping vehicle 102, generating an audible alarm to obtain attention of other entities, altering a direction of navigation of vehicle 102, and suchlike. The various vehicle operation components 140 can further include various cameras/sensors 148A-n configured to generate various images/data 149A-n relating to an environment of operation of vehicle 102.

The OCS 110 and vehicle operation components 140 can be further communicatively coupled to a glare component (GC) 150. GC 150 can be configured to (i) determine a presence of a source of bright light that can cause glare, (ii) detect presence of an entity proximate to vehicle 102, (iii) determine the entity is potentially affected by the glare, and (iv) adjust operation of vehicle 102 to mitigate a probability of the glare effect causing the entity to be involved in an accident. In an embodiment, the source of bright light can be detected by a sun component 152 configured to (i) detect sunbeams, and (ii) location of the sun relative to vehicle. In another embodiment, the bright light can be lightbeam generated by a headlight at night, whereby a headlights component 153 can be configured to detect the lightbeam and location of a headlight(s) generating the light beam.

The GC 150 can further include an entity component 158 configured to detect/determine the presence of the entity located proximate to the vehicle 102. The entity can be another vehicle, a pedestrian, a cyclist, an animal, and suchlike. The entity component 158 can be configured to determine a direction of motion, position, etc., of the entity. GC 150 can further include a vision component 156 configured to determine (e.g., in conjunction with sun component 152 and/or headlight component 153) whether the entity is affected by the sunlight or the headlight beams. In an embodiment, where vehicle 102 is a first vehicle, the entity can be a driver of a second vehicle (as detected by the vehicle detection component 163), whereby the entity component 158 can be configured to determine whether the driver is operating the second vehicle while potentially being affected by glare.

The GC 150 can further include an accident avoidance component (AAC) 165 configured to determine whether the entity is affected by glare, and based there on, a probability of the entity being involved in an accident as a result of them being affected by glare. In response to a determination by the AAC 165 that the entity is (i) not affected by glare, or (ii) even though the entity may be affected by glare, their situation is not a dangerous one, the vehicle 102 can maintain its current operation. Alternatively, in response to a determination by the AAC 165 that the entity is (i) affected by glare, and (ii) the present circumstances of the entity give rise to a probability that the entity could be involved in an accident resulting from being affected by the glare, the AAC 165 can be configured to adjust operation of vehicle 102. The operational adjustments can be initiated to mitigate the probability of the entity being involved in an accident. In an embodiment, the AAC 165 can instruct various vehicle operation components 140 to increasing/reducing velocity of vehicle 102, stop vehicle 102, generate an audible alarm to obtain attention of other entities, alter a direction of travel of vehicle 102, and suchlike.

FIG. 1B presents further detail of system 100 that can be utilized by a vehicle to reduce traffic accidents between vehicles and pedestrians, in accordance with one or more embodiments. As mentioned, system 100 comprises a vehicle 102 with various devices and components located thereon, such as OCS 110. The OCS 110 can be utilized to provide overall operational control and/or operation of vehicle 102. In an embodiment, the OCS 110 can be configured to operate/control/monitor various vehicle operations, wherein the various operations can be controlled by one or more vehicle operation components 140 communicatively coupled to the OCS 110. The various vehicle operation components 140 can include a navigation component 141 configured to navigate vehicle 102 along a road as well as to control steering of the vehicle 102. The vehicle operation components 140 can further comprise an engine component 143 (aka a motor) configured to control operation, e.g., start/stop, of an engine configured to propel the vehicle 102. The vehicle operation components 140 can further comprise a brake component 145 configured to slow down or stop the vehicle 102 (e.g., when approaching a pedestrian crossing). The brake component 145 can also be configured to control acceleration of the vehicle 102 (e.g., to increase distance from a vehicle potentially experiencing glare), wherein braking and acceleration of the vehicle 102 can form part of the DDT operational function, as previously described.

The vehicle operation components 140 can further comprise various camera and/or sensors 148A-n configured to monitor operation of vehicle 102 and further obtain imagery and other information regarding an environment/surroundings the vehicle 102 is operating in. The cameras/sensors 148A-n can include any suitable detection/measuring device, including cameras, optical sensors, laser sensors, Light Detection and Ranging (LiDAR) sensors, sonar sensors, audiovisual sensors, perception sensors, road lane sensors, motion detectors, velocity sensors, and the like, as employed in such applications as simultaneous localization and mapping (SLAM), and other computer-based technologies and methods utilized to determine an environment being navigated by vehicle 102 and the location of the vehicle 102 within the environment (e.g., location mapping). Images/data 149A-n, and the like generated by cameras/sensors 148A-n can be analyzed by algorithms 164A-n to identify respective features of interest such as a driver 104 of another vehicle 105, another vehicle 105, pedestrian/runner 106 (e.g., including respective face, posture, focus of attention/view), cyclist 107 (e.g., including respective face, posture, focus of attention/view), animal 108 (e.g., including posture, focus of attention/view), lane markings, crosswalk markings, position of sun 103, direction and/or intensity of headlight beams 186, a light source, etc. Further, the cameras/sensors 148A-n can be controlled by any of the respective components located onboard vehicle 102. For example, the vehicle detection component 163 (as further described herein) can control operation (e.g., on/off, direction/field of view, etc.) of the cameras/sensors 148A-n to enable detection of a vehicle 105A-n, as well as details of the vehicle 105A-n (e.g., make & model) to enable determination of whether the vehicle 105A-n is being operated/driven in a fully autonomous, partially autonomous, or non-autonomous manner.

As shown, vehicle 102 can further include GC 150, wherein GC 150 can further comprise various components that can be utilized to mitigate traffic accidents arising from conditions involving glare. As shown in FIG. 1B, GC 150 can be communicatively coupled to the OCS 110, the vehicle operation components 140, and other components located onboard vehicle 102.

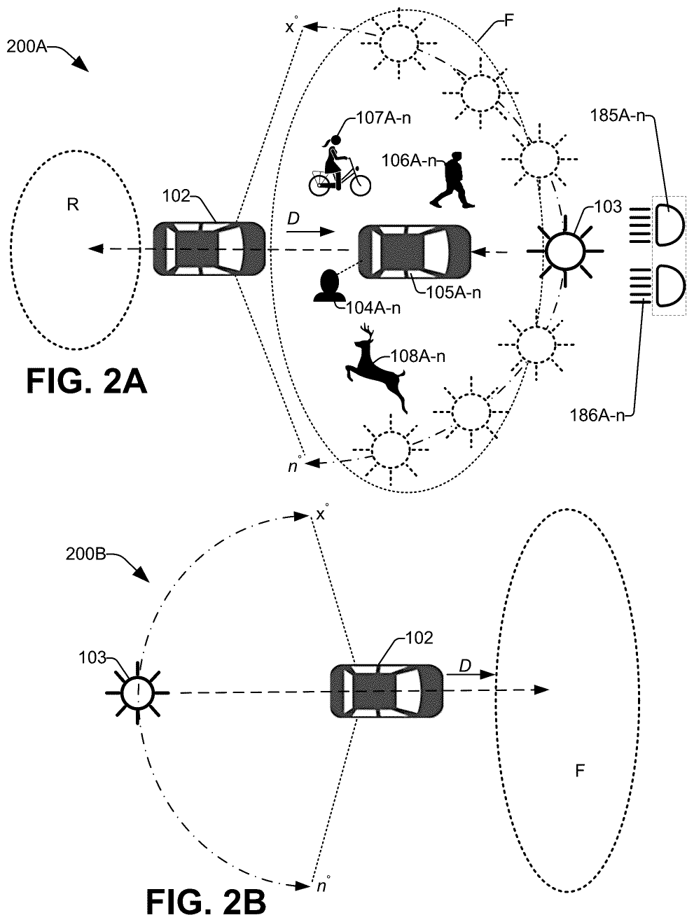

A sun component 152 can be included in GC 150, wherein the sun component 152 can be configured to detect and determine a position of the sun 103 as vehicle 102 navigates a journey, and further, presence of sunbeams 103A. Turning to FIGS. 2A and 2B, schematics 200A-B illustrate respective positions of a sun and/or a light source regarding a glare effect(s) occurring, in accordance with one or more embodiments. As shown in FIGS. 2A and 2B, the position of the sun 103 (and similarly headlights 185) can alter relative to the position of vehicle 102, as the respective positions of vehicle 102 and/or vehicles 105A-n on a road (e.g., as vehicle 102 travels in direction D) and position of the sun 103 in the sky vary. As further shown in FIGS. 2A and 2B, the respective positions of sun 103 of concern does not have to be exactly ahead of vehicle 102 or vehicles 105A-n, but can vary across a range of positions through arc x°→n°. As further shown in FIGS. 2A and 2B, respective areas of concern relate to the position of vehicle 102 and the sun 103. For example, per FIG. 2A, with the sun 103 effectively in front of vehicle 102 (e.g., as vehicle 102 travels towards sun 103 in direction D), respective drivers (e.g., drivers 104A-n) of one or more vehicles 105A-n, pedestrians 106A-n, cyclists 107A-n, animals 108A-n, etc., both in front (e.g., in region F) and to the rear (e.g., in region R) of vehicle 102 may experience deleterious glare effects. While, per. FIG. 2B, with the sun 103 positioned behind vehicle 102 (e.g., as vehicle 102 travels in direction D, the opposite of FIG. 2A), drivers 104A-n of vehicles 105A-n, pedestrian 106A-n, etc., in front (e.g., in region F) of vehicle 102 may experience deleterious glare effects. While FIGS. 2A and 2B present sun 103, its motion and respective positions, the concepts relate to glare from headlights 185A-n (and associated headlight beams 186A-n) located on one or more vehicles 105A-n.

Depending upon the time of day, the glare conditions can be exacerbated or diminished. For example, the issue of glare originating from the sun 103 is most prevalent when the sun is low to the horizon, e.g., approximately an hour or so after sunrise (e.g., experienced by drivers 104A-n driving in an easterly direction), and approximately an hour or so before sunset (e.g., experienced by drivers 104A-n driving in a westerly direction). However, the various embodiments are not directed to just those particular portions of the day, but can pertain to any hour of daylight where a driver 104 may experience sun glare, e.g., navigating an incline, sun reflection off of a building, and suchlike. In another example, the issue of glare originating from headlights 185 is most prevalent during dark operating conditions, e.g., nighttime, while driving through a tunnel, driving in an unusually dark storm, and suchlike.

As previously mentioned, glare can originate from one or more headlights 185A-n. GC 150 can further include a headlight component 153 configured with functionality and operations similar to those provided by sun component 152. However, as further described herein, the headlight component 153 can determine location of the headlights 185A-n/headlight beams 186 (e.g., based on motion of vehicle 105A-n on which the headlights 184A-n are located), intensity of headlight beam 186, and suchlike.

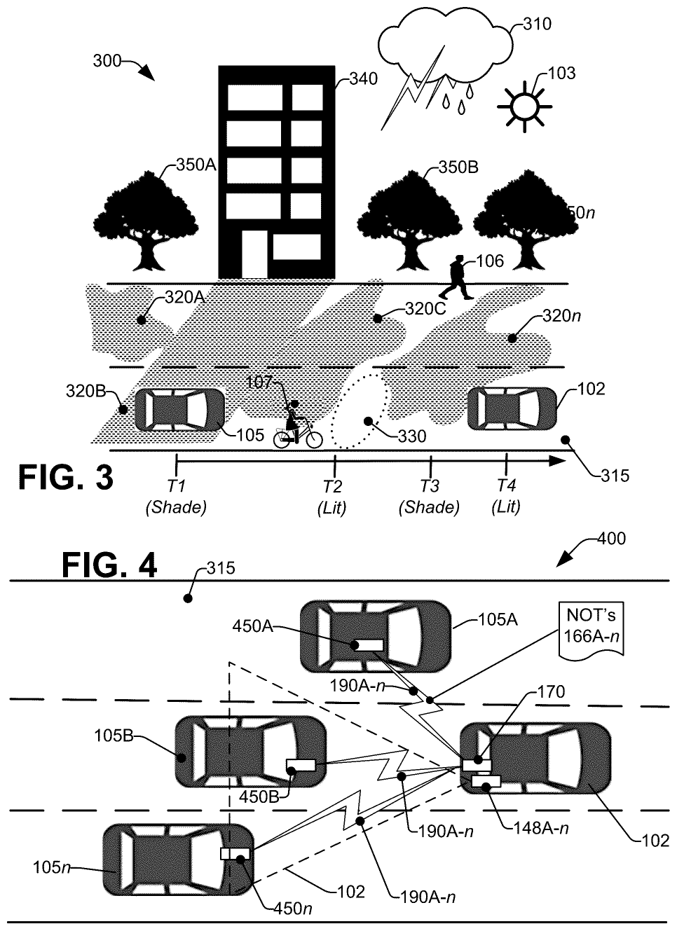

As further shown, GC 150 can also include a conditions component 154 which can be communicatively coupled to, and receive images/data 149A-n from, the cameras/sensors 148A-n. Turning to FIG. 3, schematic 300 illustrates various operating conditions that may be present during operation of a vehicle, in accordance with at least one embodiment. In an embodiment, the cameras/sensors 148A-n can be configured to detect a weather condition(s) 310 in which vehicle 102 is currently operating in, e.g., cloud-covered sky, partially cloudy sky, clear sky/sun 103 detectable, rainy, hail, snow, etc. Further, the cameras/sensors 148A-n can be configured to detect the operating conditions of vehicle 102 with regard to portions of a road 315 that are in shadow 320A-n or sunlight/sunlit 330A-n. e.g., owing to buildings 340A-n, trees 350A-n, and suchlike, casting shadows 320A-n across portions of the road 315 being navigated by vehicle 102, vehicle 105, pedestrian 106, cyclist 107, etc. The conditions component 154 can be communicatively coupled to the AAC 165, and further configured to generate and transmit road data 161 regarding the condition of road 315, location of shadow regions 320A-n, sunlit regions 330A-n, and suchlike. As further described, AAC 165 can utilize the road data 161 to determine an occurrence of a glare effect(s) and impact on driving ability of driver 104 operating vehicle 105.

The GC 150 can further include a vehicle detection component 163, wherein the vehicle detection component 163 can be configured to, in a non-limiting list, (i) detect one or more vehicles 105A-n also navigating the road being navigated by the vehicle 102, (ii) identify and monitor operation (e.g., motion, direction) of the other vehicle(s) 105A-n, (iii) communicate with the other vehicle(s) 105A-n, and suchlike, per the various embodiments presented herein. The vehicle detection component 163 can be configured to receive information regarding the vehicle 105 from data generated by the cameras/sensors 148A-n, wherein the information can be make/model of vehicle 105, license plate of vehicle 105, one or more dimensions of vehicle 105, and suchlike. Further, the vehicle detection component 163 can access a vehicle database 180 (e.g., located onboard vehicle 102) which can provide make/model information regarding vehicle 105, as further discussed herein.

In a further embodiment, GC 150 can further include a vision component 156, wherein the vision component can be configured to, in a non-limiting list, for any entity comprising a driver 104 of vehicle 105, pedestrian 106, cyclist 107, etc., (i) determine a direction of gaze/focus of the entity, (ii) determine whether the entity is engaged with their surroundings or whether their ability to resolve road conditions, other vehicles, other users, etc., is impaired by glare, e.g., originating/emanating from sun 103, headlights 185), (iii) whether the entity is attempting to cope with the glare by wearing sunglasses (e.g., sunglasses 2020), a hat, utilizing a sun-visor (e.g., sun-visor 2030) located on the vehicle 105, (iv) a degree of glare that is impinging upon the face of the entity, and such like.

The GC 150 can further include an entity component 158 which can be configured to monitor and identify (aka determine/predict/project) an entity on or by a road 315 (e.g., a pedestrian 106, cyclist 107, animal 108), a direction/trajectory of travel of the entity, a posture of the entity, a likelihood of the entity is dealing with glare-related visibility issues, is crossing or is about to cross the road, and suchlike. The entity component 158 can be configured to receive information/data from the various on-board sensors and cameras 148A-n, as well as provided by algorithms 164A-n (e.g., a computer vision algorithm, digital imagery algorithm, and suchlike), and the like. In an embodiment, the entity component 158 can be configured (e.g., in conjunction with algorithms 164A-n) to infer a future action of an entity, such as are either of pedestrian 106 or animal 108 likely to advance into the road 315 based on their current location relative to the road 315?, their respective posture?, etc.

In an embodiment, the entity component 158 can be further configured to determine an age of the one or more pedestrians 106A-n, cyclists 107A-n. As a person ages, their sight and hearing may decrease with an according required increase in response/reaction times, accordingly, an elderly person may be more susceptible to being affected by sun glare than a young adult, for example. In an embodiment, the entity component 158 can utilize face analysis algorithms 164A-n to determine the age of the pedestrian, wherein a face analysis algorithm 164 can utilize analysis of facial wrinkling/complexion, such that if no wrinkles are detected, the pedestrian 106 is determined to be a young person, while as wrinkles become more present/profuse the pedestrian 106 is determined to be an older/elderly person. Accordingly, the face analysis can be utilized to determine (i) a direction of gaze of the pedestrian, (ii) an age of the pedestrian. Further, the entity component 158 can be configured (e.g., with algorithms 164A-n) to analyze pedestrian 106's posture to provide information/make an inference regarding the age of pedestrian 106. E.g., the entity component 158 can be configured to infer the pedestrian 106's age based on their gait, stride length, walking speed, posture, and suchlike. Algorithms 164A-n (and associated machine learning techniques) can include decision tree analysis or support vector machine analysis trained to recognize specific patterns associated with specific ages of a human, e.g., gait, stride length, walking speed, posture, and suchlike. For example, an elderly pedestrian 106 is more likely to have a posture of bending forward as they walk, than a younger person. Furthermore, image analysis of images 149A-n (e.g., by algorithms 164A-n) can detect a walking aid, such as a walking stick, a walker/frame, a wheelchair, and suchlike, and based thereon can make an inference that pedestrian 106 is an older person, and hence, likely prone to reduced visibility owing to glare phenomena. Data/information generated by the entity component 158 can be transmitted to the AAC 165 to enable the AAC 165 to determine whether an accident may occur based on sunlight/headlight glare.

In a further embodiment, the entity component 158 can be further configured to detect the presence of the driver 104 in the vehicle 105A-n, wherein the entity component 158 can operate in conjunction with the vision component 156 to (i) detect the driver 104, and (ii) determine whether the driver 104 is susceptible to glare while operating vehicle 105. It is to be appreciated that while the foregoing discloses the entity component 158 is configured to determine one or more states of pedestrian 106, cyclist 107, and/or animal 108, any of vehicles 105A-n can also be considered to be an entity operating on road 315.

A road component 160 can be included in the GC 150, wherein the road component 160 can analyze information (e.g., digital images/data 149A-n) from cameras/sensors 148A-n to identify respective lane markings and suchlike, from which the road component 160 can generate road data 161 regarding a road being navigated by vehicle 102 and other respective road users. Accordingly, the road data 161 can include information regarding the width of the road, number of lanes forming the road, width of the lane(s), presence of a crosswalk and its location, and the like. The road component 160 can further receive information from a GPS data/map system 188, wherein the GPS data/map system 188 can provide information to supplement the road data 161 (e.g., location of a crosswalk, number of lanes forming the road, width of the road, width of a lane(s), and the like). Further, the road component 160 can receive road information from an external system 199 (e.g., a remote GPS system) that can further provide information regarding the road being navigated which can further supplement road data 161.

The GC 150 can further comprise various algorithms 164A-n respectively configured to determine information, make predictions, etc., regarding any of the road 315 being navigated, a velocity/location/trajectory of a person (e.g., pedestrian 106, cyclist 107) crossing/or about to cross road 315, a velocity/location/trajectory of the vehicle 102, velocity/location/trajectory of another vehicle (e.g., vehicle(s) 105A-n), a time it will potentially take a pedestrian 106 to cross the road 315, a potential intersection of the trajectory of the pedestrian 106 and a vehicle 102 and/or vehicle 105A, whether a driver 104 is experiencing a glare effect, glare effect occurrence from sunbeams 103A/headlight beams 186, and suchlike. Algorithms 164A-n can include a computer vision algorithm(s), a digital imagery algorithm(s), position prediction, velocity prediction, direction prediction, and suchlike, to enable the respective determinations, predictions, etc., per the various embodiments presented herein. Algorithms 164A-n can be utilized by any system/component/device located onboard vehicle 102.

An AAC 165 can be further included in the GC 150, wherein the AAC 165 can be configured to, in a non-limiting list: (i) determine/infer a likelihood/probability of an accident occurring between any of the respective road users, e.g., vehicle 102, other vehicles 105A-n, pedestrians 106A-n, cyclists 107A-n, animals 108A-n, and suchlike, (ii) in response to a determination/inference of a likelihood/probability of an accident occurring being above a threshold, alter operation of the vehicle 102, (iii) in response to a determination/inference of a probability of an accident occurring being above a threshold, indicate to another entity the probability of an accident occurring such that the other entity (e.g., driver 104, vehicle(s) 105A-n, pedestrian 106, cyclist 107, animal 108), can adjust their operation/behavior to mitigate the probabiltiy of the accident occurring (iv) in response to a determination/inference of a probability of an accident occurring is below a threshold, the vehicle 102 maintains operation, and suchlike. As shown in FIG. 1, the AAC 165 can be configured to analyze the wealth of information generated (e.g., by any of the components located onboard vehicle 102) regarding any of the other entities: vehicles 105A-n, pedestrians 106A-n, cyclists 107A-n, and/or animals 108A-n (e.g., their respective speed, velocity, motion, trajectory of travel, degree of being subject to glare, and suchlike.) as well as the motion, speed, direction, etc., of vehicle 102 relative to the other entities. The AAC 165 can be configured to generate one or more notifications 166A-n regarding a respective likelihood of an accident occurring between the vehicle 102 and the other entities, as well as a respective likelihood of an accident occurring between one or more of the entities themselves (e.g., vehicle 105 colliding with a pedestrian 106).

The AAC 165 can be further configured to determine one or more actions for vehicle 102 to undertake to mitigate the likelihood of an accident occurring, whether the accident involves vehicle 102 and one or more of entities: vehicle(s) 105A-n, pedestrian(s) 106A-n, cyclist(s) 107A-n, and/or animal(s) 108A-n, or, alternatively, vehicle 102 is not involved in an accident between any of the entities 105A-n, 106A-n, 107A-n, and/or 108A-n, vehicle 102 can perform an action(s) to potentially prevent the accident occurring between any of the entities 105A-n. 106A-n. 107A-n, and/or 108A-n. The various actions include, in a non-limiting list, any of: (i) vehicle 102 slows down, stops, accelerate to increase a driving distance between a vehicle 105 following vehicle 102 (e.g., to prevent a rear-end collision), change current lane of operation, attempt to communicate with another vehicle, honk horn, emit an alarm/warning notice comprising a sound or a phrase such as “look right, vehicle approaching!”, “stop, vehicle approaching”, and suchlike.

The GC 150 can further include a warning component 168. The warning component 168 can be configured to operate in conjunction with the AAC 165, wherein the warning component 168 can receive a notification 166A from the AAC 165 that there is a high likelihood of collision between any of the respective entities 104, 105A-n, 106A-n, 107A-n, and/or 108A-n. In response to receiving the notification 166A, the warning component 168 can interact with the devices component 146 to initiate operation of the headlights, car horn, etc., to obtain the attention of any of the driver 104, pedestrians 106A-n, cyclists 107A-n, and/or animals 108A-n. In a further embodiment, as described herein, the warning component 168 can also generate a warning(s) via communications technology configured to interact between the vehicle 102 (e.g., operating as a first vehicle) and vehicle 105 (e.g., operating as a second vehicle). The communications technology interaction can be undertaken via a communications component 170. The communications component 170 can be included in GC 150. The communications component 170 can be configured to communicate and interact with communication systems respectively located onboard the vehicles 105A-n. The communications component 170 can be configured to establish and conduct communications with other vehicles on the road, external entities and systems, etc., e.g., via I/O 116. In an embodiment, the communications component 170 can be configured to generate and transmit an instruction 166A-n to other vehicles 105A-n requesting the vehicles 105A-n identify whether the respective vehicle 105A-n is being operated in any of non-autonomously, partially autonomously, or fully autonomously. The communications component 170 can be further configured to receive an indication 166A-n from the respective vehicle 105A-n regarding operation of the respective vehicle 105A-n, and further, indicate the respective operation (e.g., non-autonomously, partially autonomously, or fully autonomously) of respective vehicle 105A-n to the AAC 165, wherein the AAC 165 can be configured to determine whether operation of the vehicle 105A-n should be maintained regarding the driver 104 operating under conditions of glare (e.g., vehicle 105A-n is operating non-autonomously or partially autonomously) or vehicle 105A-n is not operating under conditions of glare (e.g., vehicle 105A-n is operating autonomously with no involvement of a driver 104).

In an embodiment, the communications component 170 can be further configured to generate the notification 166A-n requesting the vehicle 105A-n identifies whether it is being operated non-autonomously, partially autonomously, or fully autonomously in response to a determination by the entity component 158 being unable to determine whether a vehicle 105A-n has a driver 104 present.

Vehicle 102 can also include a vehicle database 180, wherein the vehicle database 180 can comprise various vehicle identifiers such as makes/models, a list of license plates and vehicles they are registered to, and suchlike, to enable determination of one or more features regarding a vehicle 105 operating in the locality of vehicle 102 (e.g., detected by the vehicle detection component 163). Make/model of vehicle 105 can be determined from the license plate and/or the make/model of the lead vehicle as determined by analysis of imagery of vehicle 105A-n captured by the one or more cameras 148A-n and a computer vision algorithm(s) in algorithms 164A-n. In an embodiment, the vehicle database 180 can also include information regarding whether vehicle 105 is configured to be driven autonomously, partially autonomously, or non-autonomously. By obtaining such information regarding autonomous, partial-, or non-autonomous operation, the vehicle detection component 163 can make a determination as to whether a particular vehicle 105A-n is relying on a human driver 104 to operate the vehicle 105A-n, and if so, one or more components onboard vehicle 102 can focus attention on the driver 104 and/or operation of vehicle 105, while paying less attention to a vehicle 105B that is being driven fully autonomously.

As shown in FIG. 1B, the OCS 110 can further include a processor 112 and a memory 114, wherein the processor 112 can execute the various computer-executable components, functions, operations, etc., presented herein. The memory 114 can be utilized to store the various computer-executable components, functions, code, etc., as well as road data 161, algorithms 164A-n, notifications 166A-n, information (e.g., motion, trajectory, location) regarding any of vehicle 102, vehicle 105A-n, pedestrian 106A-n, cyclist 107A-n, animal 108A-n, location of sun 103 and sunbeams 103A, headlights 185 and headlight beams 186, shadow regions 320A-n, sunlit regions 330A-n, whether vehicle 105A-n is being operated autonomously, partially-autonomously, non-autonomously, whether driver 104 is susceptible to glare or not, and suchlike (as further described herein). In an embodiment, the vehicle operation components 140 can form a standalone component communicatively coupled to the OCS 110, and while not shown, the vehicle operation components 140 can operate in conjunction with a processor (e.g., functionally comparable to processor 112) and a memory (e.g., functionally comparable to memory 114) to enable navigation, steering, braking/acceleration, etc., of vehicle 102 to a destination. In another embodiment, the vehicle operation components 140 can operate in conjunction with the processor 112 and memory 114 of the OCS 110, wherein the various control functions (e.g., navigation, steering, braking/acceleration) can be controlled by the OCS 110. Similarly, the GC 150 can form a standalone component communicatively coupled to the OCS 110, and while not shown, the GC 150 can operate in conjunction with a processor (e.g., functionally comparable to processor 112) and a memory (e.g., functionally comparable to memory 114) to enable glare detection, e.g., during operation of vehicle 102. In another embodiment, the GC 150 can operate in conjunction with the processor 112 and memory 114 of the OCS 110, wherein the various glare detection functions can be controlled by the OCS 110. In a further embodiment, the OCS 110, vehicle operation components 140, and the GC 150 (and respective sub-components) can operate using a common processor (e.g., processor 112) and memory (e.g., memory 114).

As further shown, the OCS 110 can include an input/output (I/O) component 116, wherein the I/O component 116 can be a transceiver configured to enable transmission/receipt of information 198 (e.g., a notification 166A-n, and suchlike) between the OCS 110 and any external system(s) (e.g., external system 199), e.g., an onboard system of vehicle 105A-n, a cellphone, a GPS data system, and suchlike. I/O component 116 can be communicatively coupled, via an antenna 117, to the remotely located devices and systems (e.g., external system 199). Transmission of data and information between the vehicle 102 (e.g., via antenna 117 and I/O component 116) and the remotely located devices and systems can be via the signals 190A-n. Any suitable technology can be utilized to enable the various embodiments presented herein, regarding transmission and receiving of signals 190A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

In an embodiment, the OCS 110 can further include a human-machine interface (HMI) 118 (e.g., a display, a graphical-user interface (GUI)) which can be configured to present various information including imagery of/information regarding vehicle 102, vehicles 105A-n, pedestrians 106A-n, cyclists 107A-n, animals 108A-n, the road 315, alarms, warnings (e.g., vehicle 102 is braking, vehicle 102 is accelerating, information received from external systems and devices, etc., per the various embodiments presented herein. The HMI 118 can include an interactive display 119 to present the various information via various screens presented thereon, and further configured to facilitate input of information/settings/etc., regarding operation of the vehicle 102. In an embodiment, in the event that vehicle 102 is being operated in an autonomous manner (e.g., Level 5 of SAE J3016), operation of the warning component 168 and notifications 166A-n can be utilized to present a warning on the HMI 118 and screen 119 to notify a passenger of vehicle 102 of the possible collision with vehicle 105A-n, an accident avoiding maneuver, and suchlike.

It is to be appreciated that while the term “notification” is presented herein with regard to notifications 166A-n, the content of notifications 166A-n is not limited to notifications, but can include data, information, instructions, requests, responses, and suchlike, and further the notifications 166A-n can be generated, transmitted, and/or received by any of the components located and operating onboard vehicle 102. The respective components are configured to analyze, generate, act upon, transmit, and receive data between the components (e.g., vehicle operation components 140 and subcomponents, GC 150 and subcomponents, communications component 170, vehicle database 180, GPS data 188, and the OCS 110, an external system 199, and further to other vehicles 105A-n.

FIG. 4, schematic 400 illustrates various vehicles, wherein at least one of the vehicles is configured to determine operation of the other vehicles, in accordance with an embodiment. In an embodiment, as previously mentioned, vehicle 102 can be equipped with various onboard cameras/sensors 148A-n configured to provide images and/or data 149A-n from which the presence of one or more vehicles 105A-n can be determined. The images/data 149A-n can be analyzed by the vehicle detection component 168 in conjunction with, for example, vehicle data stored in the vehicle database 180 and algorithms 164A-n, such that the vehicle detection component 168 can make a determination regarding whether vehicles 105A-n are respectively being operated in an autonomous manner, a partially autonomous manner, or in a non-autonomous manner. For example, based on manufacturer and model information, it is possible to determine that a vehicle 105 was manufactured prior to the manufacturer implementing autonomous-only operation on its range of vehicles, hence, with vehicle 105 being built before such an implementation, vehicle detection component 168 can infer that vehicle 105 cannot be driven autonomously, it only has partially-autonomous or non-autonomous operation and hence the driver 104 may be susceptible to glare. In the example scenario presented in FIG. 4, vehicle 105A can be operating in a non-autonomous manner, vehicle 105B can be operating in a partially autonomous manner, and vehicle 105n can be operating in a fully autonomous manner. In the event of determining a vehicle, e.g., vehicle 105n is being operated autonomously, the vehicle detection component 168 can be configured to pay less attention to operation of the autonomous vehicle 105n regarding glare effects as this vehicle is being operated based on onboard sensors, cameras, GPS data, etc., utilized by navigation systems onboard vehicle 105n. However, given the partially autonomous operation of vehicle 105B and non-autonomous operation of vehicle 105A, both vehicles 105A and 105B have a driver (e.g., drivers 104A and 104B) respectively operating vehicle 105A and 105B, wherein the driver can be susceptible to issues of glare.

In a further embodiment, to supplement information/data derived from images/data 149A-n, vehicle 102 can be configured to communicate with vehicles 105A-n. For example, communication technology can be deployed across the various vehicles to enable vehicle-to-vehicle communication. In an embodiment, vehicle 102 can include a communications component 170 configured to communicate (e.g., via signals 190A-n) with a corresponding communications component 450A-n respectively operating on vehicle(s) 105A-n. Communications component 170 can be configured to generate and transmit a request 166A-n to vehicles 105A-n instructing vehicles 105A-n to provide information regarding what form of operation is available at the respective vehicle, e.g., are vehicles 105A-n respectively operating autonomously, partially autonomously, or non-autonomously. As previously described, the onboard GC 150 can be configured to focus on vehicles 105A-n indicating they are being operated by a human driver 104 (e.g., notification 166A-n received from a communications component 450A-n on vehicle 105A-n indicates partially autonomous and/or non-autonomous operation) rather than receiving a notification 166A-n that vehicle 105A-n is operating autonomously.

Based on the foregoing, the following series of figures present various example scenarios of operation and one or more operations/actions that vehicle 102 can perform in such scenarios to reduce/mitigate likelihood of an accident/collision occurring between vehicle 102 and any of one or more vehicles 105A-n, pedestrian(s) 106A-n, cyclist(s) 107A-n, animal(s) 108A-n, and suchlike.

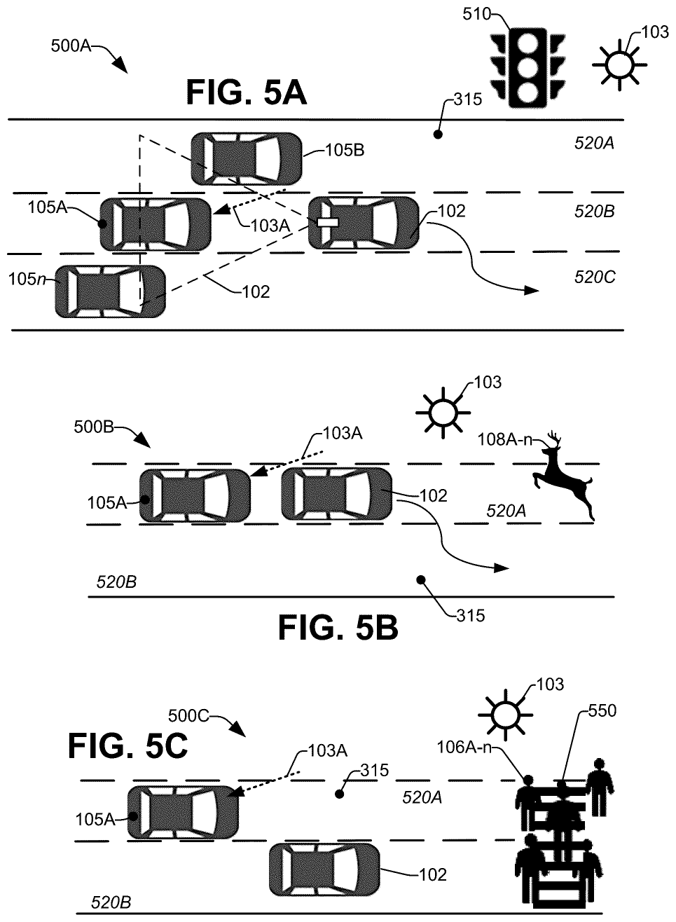

FIGS. 5A-C, schematics 500A-500C, present actions that can be performed by vehicle 102 in response to respective scenarios, in accordance with one or more embodiments. FIG. 5A, schematic 500A illustrates a plurality of vehicles 102 and 105A-n approaching on road 315 a traffic light (traffic signal) 510, wherein the vehicle detection component 163 has detected (e.g., via any of cameras/sensors 148A-n, images/data 149A-n, vehicle database 180, communications component 170) vehicle 105A is being operated in a partially autonomous or non-autonomous manner while driving along lane 520B of a three lane road (e.g., lanes 520A-C), and further, vehicles 105B and 105n are operating autonomously. Accordingly, AAC 165 is configured to monitor operation of vehicle 105A. Sun component 152 determines that the sun 103 is positioned such that glare can occur, with sunbeams 103A incident upon driver 104's face of vehicle 105A, and further, the vision component 156 can be configured to obtain information (e.g., via cameras/sensors 148A-n and images/data 149A-n) regarding whether the driver 104 of vehicle 105A is susceptible to glare effects. In the example scenario presented, the condition of traffic light 510 could change to red, requiring vehicles 102 and 105A to stop, but owing to the effects of sun glare, driver 104 may not see the traffic light 510 changing to red and does not brake, which can lead to vehicle 105A rear-ending vehicle 102. In the example scenario presented, road component 160 (e.g., via cameras/sensors 148A-n and images/data 149A-n) can be configured to detect the traffic light 510 and its state of operation (e.g., red, stop, green, slow, amber, prepare to stop, etc.), whereupon the road component 160 can generate and transmit a notification 166A-n informing AAC 165 of the location of the traffic light 510, distance from vehicle 102, duration of time before vehicle 102 will be at the location of traffic light 510, and suchlike. In response to making a determination that YES, driver 104 is operating vehicle 105A while being potentially influenced by glare, vehicle 102 can take action to avoid being in a collision (e.g., rear-ended) with vehicle 105A. In response to a request 166A-n from AAC 165, road component 160 can make a determination that it is safe for vehicle 102 to change lanes (e.g., from lane 520B to 520C), and based thereon, AAC 165 can generate and transmit a notification 166A-n to the navigation component 141 instructing navigation component 141 to change lanes, thereby opening up lane 520B in case the condition of traffic light 510 changes to stop. In response to receiving the notification 166A-n, the navigation component 141 steers vehicle 102 into lane 520C and out of the path of vehicle 105A.

FIG. 5B, schematic 500B illustrates vehicles 102 and 105A-n driving along a road 315 having two lanes 520A and 520B. Vehicle detection component 163 has detected (e.g., via any of cameras/sensors 148A-n, images/data 149A-n, vehicle database 180, communications component 170) vehicle 105A is being operated in a partially autonomous or non-autonomous manner. Sun component 152 has detected position of sun 103 and determined that driver 104 of vehicle 105A has potential to be affected by sun glare by sunbeams 103A incident upon driver 104's face, and further, the vision component 156 can be configured to obtain information (e.g., via cameras/sensors 148A-n and images/data 149A-n) regarding whether the driver 104 of vehicle 105A is susceptible to glare effects. In the example scenario presented, an animal 108 is present in the lane 520A, and detected by entity component 158, whereupon the entity component 158 can generate and transmit a notification 166A-n informing AAC 165 of the location of animal 108, distance from vehicle 102, duration of time before vehicle 102 will be at the location of animal 108, and suchlike. In an embodiment, the AAC 165 can make a determination that driver 104 is likely not aware of the animal 108 (e.g., based upon the glare susceptibility notification 166A-n from vision component 156), and can generate and transmit a notification to the brake component 145 to reduce the velocity of vehicle 102 with the intent that, even though driver 104 cannot see animal 108, driver 104 responds to seeing vehicle 102 braking (e.g., brake lights). Further, AAC 165 can generate and transmit an instruction 166A-n to the navigation component 141 to change lanes from lane 520A to lane 520B, and can further generate and transmit an instruction 166A-n to the devices component 146 instructing the devices component 146 to activate an onboard car horn/audible device to (a) obtain attention of driver 104 regarding the presence of animal 108 and further, (b) scare animal 108 away from the road.

FIG. 5C, schematic 500C illustrates vehicles 102 and 105A-n driving along a road 315 having two lanes 520A and 520B. Vehicle detection component 163 has detected (e.g., via any of cameras/sensors 148A-n, images/data 149A-n, vehicle database 180, communications component 170) vehicle 105A is being operated in a partially autonomous or non-autonomous manner. Sun component 152 has detected position of sun 103 and determined that driver 104 has potential to be affected by sun glare by sunbeams 103A incident upon driver 104's face, and further, the vision component 156 can be configured to obtain information (e.g., via cameras/sensors 148A-n and images/data 149A-n) regarding whether the driver 104 of vehicle 105A is susceptible to glare effects. In the example scenario presented, one or more pedestrians 106A-n are crossing road 315 at a pedestrian crossing/crosswalk 550 (although pedestrians 106A-n could be crossing road 315 at any point), and detected by entity component 158, whereupon the entity component 158 can generate and transmit a notification 166A-n informing AAC 165 of the location of pedestrian(s) 106A-n, distance from vehicle 102, duration of time before vehicle 102 will be at the location of pedestrian(s) 106A-n, and suchlike. In an embodiment, the AAC 165 can make a determination that driver 104 is likely not aware of pedestrian(s) 106A-n, e.g., vehicle detection component 163 can determine whether vehicle 105A is slowing. In response to a determination that driver 104 is not acting in a manner responsive to avoid colliding with pedestrian(s) 106A-n, the AAC 165 can be configured to generate and transmit an instruction 166A-n to the devices component 146 instructing the devices component 146 to activate an onboard car horn/audible device to (a) get attention of driver 104 regarding the presence of pedestrian(s) 106A-n and further, (b) get the attention of the pedestrian(s) 106A-n regarding the oncoming vehicle 105A.

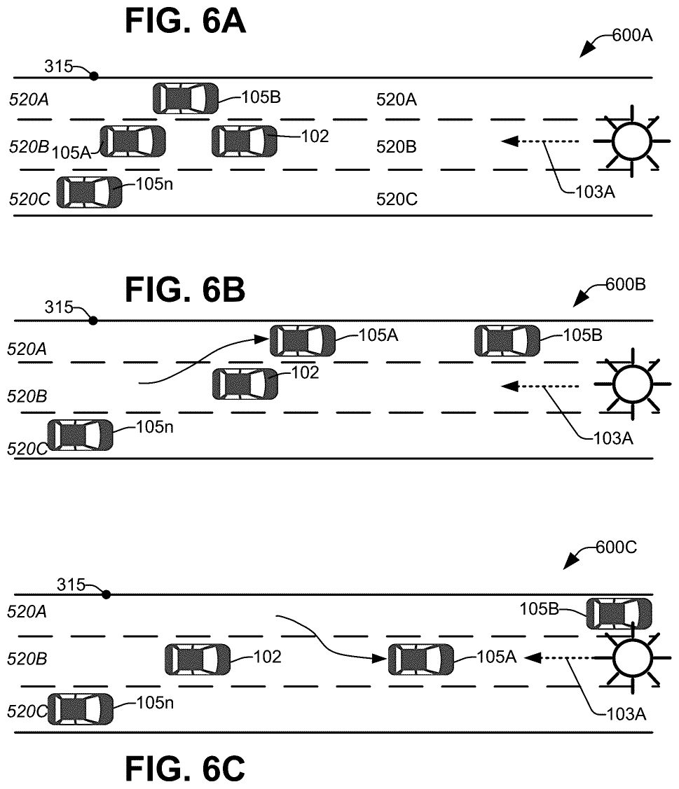

FIGS. 6A-C, schematics 600A-C, present a scenario of operation of an autonomous vehicle responsive to operation of a second vehicle, in accordance with one or more embodiments. FIG. 6A, schematic 600A illustrates a group of vehicles 102 and 105A-n driving along a road 315 with multiple lanes (e.g., lanes 520A-C). The vehicle detection component 163 onboard vehicle 102 has detected (e.g., via any of cameras/sensors 148A-n, images/data 149A-n, vehicle database 180, communications component 170) vehicle 105A is being operated in a partially autonomous or non-autonomous manner while driving along lane 520B, and further, vehicles 105B and 105n are operating autonomously. Accordingly, AAC 165 can be configured to monitor operation of vehicle 105A. Sun component 152 determines that the sun 103 is positioned such that glare can occur, with sunbeams 103A incident upon driver 104's face of vehicle 105A, and further, the vision component 156 can be configured to obtain information (e.g., via cameras/sensors 148A-n and images/data 149A-n) regarding whether the driver 104 of vehicle 105A is susceptible to glare effects. In the example scenario presented, vehicle 105A is being driven at speed and switches from lane 520B to 520A (per FIGS. 6A and 6B) and further navigates from lane 520A to lane 520B (per FIGS. 6B and 6C), whereupon vehicle 105A is now in front of vehicle 102, with vision of driver 104 of vehicle 105A being susceptible to glare (e.g., as detected by vision component 156). AAC 165 can be configured, based on the various information generated and transmitted to the AAC 165, that vehicle 105A may be being operated in a reckless manner such that vehicle 105A could be involved in an accident. In response to making a determination that YES, driver 104 is operating vehicle 105A while being potentially influenced by glare, vehicle 102 can take action to avoid being in a collision (e.g., rear-ending) with vehicle 105A. AAC 165 can generate and transmit a notification 166A-n to the navigation component 141/brake component 145 instructing navigation component 141/brake component 145 to slow down vehicle 102 to enable a safe braking distance to be established between vehicle 102 and vehicle 105A to prevent collision of vehicle 102 with vehicle 105A in the event that vehicle 105A is involved in an accident.

Further, operation of vehicle 102 and the respective onboard systems and components can be configured to determine whether other vehicles 105A-n, other entities 106A-n, 107A-n, 108A-n may be proximate to a route/direction being driven by vehicle 102. FIG. 7, schematic 700, illustrates a scenario of operation of an autonomous vehicle responsive to operation of a second vehicle, in accordance with one or more embodiments. As shown, vehicle 102 is driving towards vehicle 105, where vehicle 105 is positioned at a road junction (crossroads 315A and 315B) and potentially can drive towards road 315B or turn onto road 315A (e.g., as detected by road component 160). The vehicle detection component 163 onboard vehicle 102 has detected (e.g., via any of cameras/sensors 148A-n, images/data 149A-n, vehicle database 180, communications component 170) vehicle 105 is being operated in a partially autonomous or non-autonomous manner, and further, the respective location of vehicle 105. Accordingly, AAC 165 can be configured to monitor operation of vehicle 105. Sun component 152 determines that the sun 103 is positioned such that glare can occur, with sunbeams 103A incident upon driver 104's face, and further, the vision component 156 can be configured to obtain information (e.g., via cameras/sensors 148A-n and images/data 149A-n) regarding whether the driver 104 of vehicle 105A is susceptible to glare effects. In the example scenario presented, motion of vehicle 105A can cause a collision with vehicle 102. AAC 165 can be configured, based on the various information generated and transmitted to the AAC 165, to determine the likelihood of collision. In response to making a determination that YES, driver 104 is operating vehicle 105A while being potentially susceptible to glare from sunbeams 103A, vehicle 102 can take action to avoid being in a collision with vehicle 105A. AAC 165 can generate and transmit a notification 166A-n to the navigation component 141/brake component 145 instructing navigation component 141/brake component 145 to slow down to enable vehicle 105 to perform its maneuver, perform a lane change (if safe to do so), and suchlike. The AAC 165 can also be configured to generate and transmit an instruction 166A-n to the devices component 146 instructing the devices component 146 to activate an onboard car horn/audible device to get attention of driver 104 regarding the presence of vehicle 102.

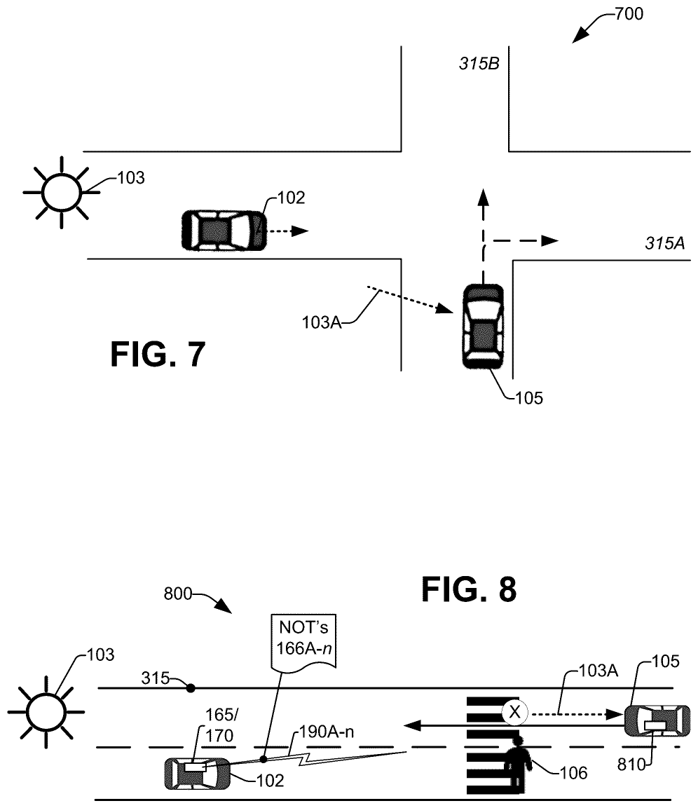

FIG. 8, schematic 800 presents a scenario of a first vehicle operating to avoid an accident between a second vehicle and a pedestrian, in accordance with one or more embodiments. Per the previously described techniques, vehicle 102 can determine that vehicle 105 (as detected by vehicle detection component 163) advancing towards the pedestrian 106 (as detected by entity component 158) crossing the road is being driven in a partially autonomous manner or a non-autonomous manner, with sunbeams 103A from sun 103 incident upon the face of driver 104 (as detected by vision component 156) operating vehicle 105. Based on such parameters as velocity of vehicle 105, vehicle 105 is not braking, speed with which pedestrian 106 is crossing the road/or has a posture of being about to cross the road, AAC 165 can make a determination that vehicle 105 will likely collide with pedestrian 106 at position X. AAC 165 can generate and transmit a notification 166A-n to the navigation component 141/brake component 145 instructing navigation component 141/brake component 145 to slow down/stop vehicle 102. The AAC 165 can also be configured to generate and transmit an instruction 166A-n to the devices component 146 instructing the devices component 146 to activate an onboard car horn/audible device to get attention of driver 104 regarding the presence of pedestrian 106, wherein the audible device can transmit a warning such as “pedestrian in crossing”, “pedestrian in crossing vehicle to your right”, and suchlike. As mentioned previously, vehicle-to-vehicle communications can be conducted (e.g., via communications component 170 onboard vehicle 102 and respective computer system (OCS) 450 onboard vehicle(s) 105A-n) whereby AAC 165 can generate and transmit an instruction 166A-n to vehicle 105 warning vehicle 105 of the pedestrian 106, whereby the notification 166A-n can be presented on a display screen located onboard vehicle 105. Further, notification 166A-n can further include an instruction to OCS 450 instructing OCS 450 to operate a braking system onboard vehicle 105 to slow down/stop vehicle 105 while pedestrian 106 crosses the road 315. In an embodiment, the notification 166A-n can have a level of urgency applied to it such that OCS 450 is configured to automatically respond to the notification 166A-n.

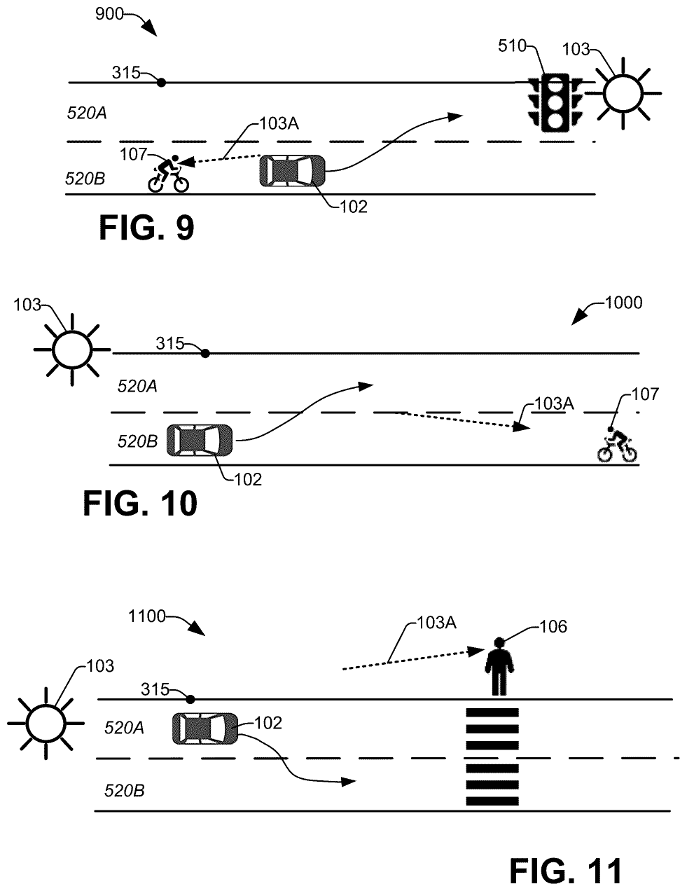

FIG. 9, schematic 900 presents a scenario of a first vehicle operating to avoid an accident with a cyclist, in accordance with one or more embodiments. Per the previously described techniques, the road component 160 can detect the traffic light 510 and the entity component 158 can determine the presence of cyclist 107. Further, the vision component 156 can determine that cyclist 107 is potentially affected by sunbeams 103A from sun 103 incident upon the face of cyclist 107. Given the respective locations of vehicle 102 and cyclist 107 relative to the traffic light 510, AAC 165 can make a determination regarding whether cyclist 107 would cycle into (or be dangerously proximate to) vehicle 102 in the event of vehicle 102 slowing/stopping. In response to a determination of YES, in the event of cyclist 107 does not see vehicle 102, there is a danger of cyclist 107 colliding with vehicle 102, AAC 165 can generate and transmit an instruction 166A-n to the navigation component 141 to change operation of vehicle 102 from lane 520B to lane 520A, and can further generate and transmit an instruction 166A-n to the devices component 146 instructing the devices component 146 to activate an onboard car horn/audible device to get attention of cyclist 107.

FIG. 10, schematic 1000 presents a scenario of a first vehicle operating to avoid an accident with a cyclist, in accordance with one or more embodiments. The entity component 158 can determine the presence of cyclist 107 cycling towards vehicle 102. Per the previously described techniques, vision component 156 can determine that cyclist 107 is potentially affected by sunbeams 103A from sun 103 incident upon the face of cyclist 107. Given the respective locations of vehicle 102 and cyclist 107, AAC 165 can make a determination regarding whether cyclist 107 would cycle into (or be dangerously proximate to) vehicle 102 in the event of vehicle 102 and/or cyclist 107 maintaining their current respective routes and/or velocities. In response to a determination of YES, in the event of cyclist 107 does not see vehicle 102, a collision between vehicle 102 and cyclist 107 is likely, AAC 165 can generate and transmit an instruction 166A-n to the navigation component 141 to change operation of vehicle 102 from lane 520B to lane 520A, and can further generate and transmit an instruction 166A-n to the devices component 146 instructing the devices component 146 to activate an onboard car horn/audible device to get attention of cyclist 107.

FIG. 11, schematic 1100 presents a scenario of a vehicle operating to avoid an accident with a pedestrian, in accordance with one or more embodiments. The entity component 158 can determine the presence of pedestrian 106 and pedestrian 106 has the motion/posture that pedestrian 106 appears to be about to cross the road 315 and/or is in the process of crossing the road 315. Per the previously described techniques, vision component 156 can determine that pedestrian 106 is potentially affected by sunbeams 103A from sun 103 incident upon the face of pedestrian 106 and accordingly, pedestrian 106 may not be aware/have seen vehicle 102 advancing towards the pedestrian 106. Given the respective locations of vehicle 102 and pedestrian 106, AAC 165 can make a determination regarding whether a collision may occur between vehicle 102 and pedestrian 106 in the event of vehicle 102 maintaining its current route/velocity and pedestrian 106 crossing the road 315. In response to a determination of YES, in the event of pedestrian 106 not seeing vehicle 102, a collision between vehicle 102 and pedestrian 106 is likely, AAC 165 can (a) generate and transmit an instruction 166A-n to the navigation component 141 to change operation of vehicle 102 from lane 520A to lane 520B, (b) generate and transmit an instruction 166A-n to the devices component 146 instructing the devices component 146 to activate an onboard car horn/audible device to get attention of pedestrian 106, and/or (c) generate and transmit a notification 166A-n to the navigation component 141/brake component 145 instructing navigation component 141/brake component 145 to slow down/stop to enable pedestrian 106 to cross road 315, and suchlike.

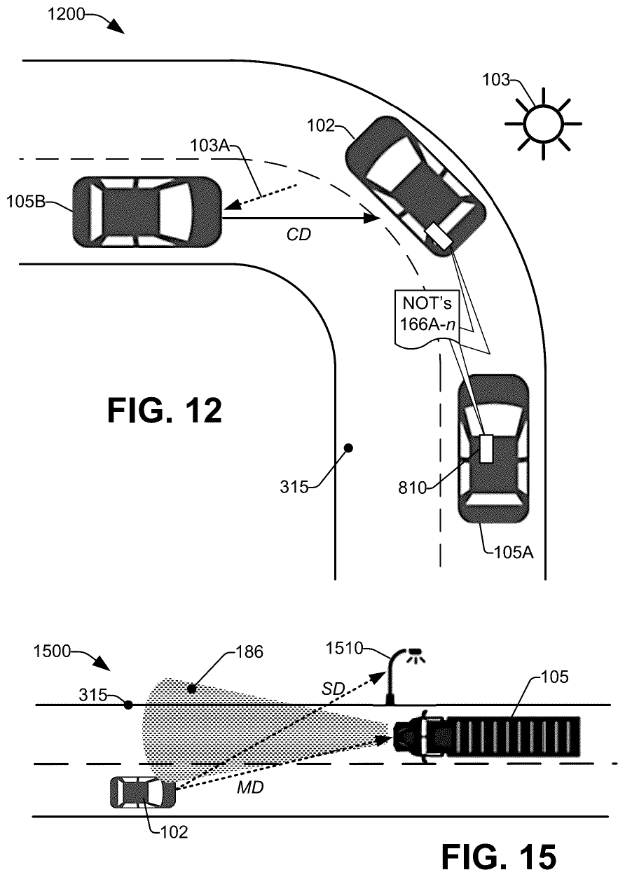

FIG. 12, schematic 1200 presents a scenario of a first vehicle operating and communicating with a second vehicle to prevent the second vehicle from colliding with a third vehicle, in accordance with one or more embodiments. As shown, a first vehicle, vehicle 102, is navigating a turn/curve/bend in road 315 and is being followed by a second vehicle, vehicle 105A, whereby vehicle 105A will momentarily also be navigating the turn. A third vehicle, vehicle 105B is driving towards the turn, and per the previously described techniques, vision component 156 can determine that driver 104 operating vehicle 105B is potentially affected by sunbeams 103A from sun 103 incident upon the face of driver 104, and accordingly, driver 104 may not be aware/have seen the turn approaching, wherein if vehicle 105B maintains a current direction CD, vehicle 105B could collide with vehicle 102 and/or vehicle 105A. At that moment in time, vehicle 105A may not be aware of vehicle 105B advancing toward the turn. Given the respective locations of vehicle 102, and vehicles 105A and 105B, AAC 165 can make a determination regarding whether a collision may occur between vehicle 105B and vehicles 102 and/or 105A. In response to a determination of YES, in the event of vehicle 105B maintains its current direct CD, a collision between vehicle 105B and either of vehicle 102 and/or 105A is likely, AAC 165 can conduct vehicle-to-vehicle communication with vehicle 105A, as previously described. As mentioned previously, vehicle-to-vehicle communications can be conducted (e.g., via communications component 170 onboard vehicle 102 and computer system 450 respectively located onboard vehicle(s) 105A-n) whereby AAC 165 can generate and transmit an instruction 166A-n to vehicle 105A instructing vehicle 105A of vehicle 105B approaching the turn and potentially colliding with vehicle 105B in the event that driver 104 of vehicle 105B does not change the direction of operation from CD. Vehicle 105B can respond to vehicle 102 with a notification 166A-n indicating the warning has been received, and further, vehicle 105B can change its operation to avoid collision with vehicle 105B.

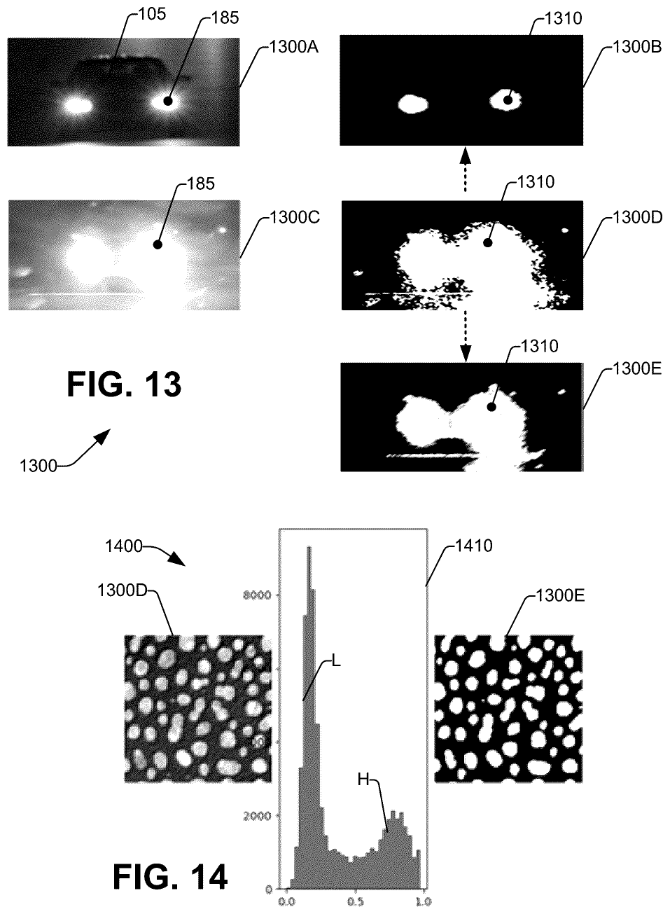

As previously mentioned, GC 150 can also include a headlight component 153, wherein headlight component 153 can be configured to detect the presence of one or more headlights 185A-n and the beams of light 186A-n generated thereby. In an embodiment, the headlight component 153 can be configured to perform operations similar to those configured for sun component 152 with regard to identification of a location of one or more headlights 185A-n, beams of light 186A-n and their direction relative to a driver 104 or a pedestrian 106, cyclist 107, and/or animal 108. FIG. 13, images 1300A-E present concepts relating to headlight beam detection and determination, according to one or more embodiments. As shown in image 1300A (e.g., a digital image 149A-n), a vehicle 105 is driving with headlights 185A-n operable, whereby image 1300A can be captured and generated by cameras/sensors 148A-n. Image 1300B is a digital mapping 149A-n of image 1300A whereby the digital mapping has extracted the portions of the image 1300A pertaining to light beams 186A-n emitted by headlights 185A-n. In an embodiment, the headlight component 153 can be configured to perform the digital mapping of image 1300A (e.g., in conjunction with cameras/sensors 148A-n, images/data 149A-n, algorithms 164A-n, and suchlike). In an example scenario, vehicle 105 is operating with headlights 185A-n set at low beam/dipped beam, accordingly, the beams of light 186A-n form regions 1310 on the image 1300B. To assist the headlight component 153 in determining whether headlights 185A-n are operating in low beam or high beam, a distance sensor 148 can provide distance information in images/data 149A-n regarding the distance between vehicle 105 and vehicle 102, as described further below. In an embodiment, cameras/sensors 148A-n can include a distance sensor 148 configured to provide a distance at which the vehicle 105 was located when the any of the images 149A-n/1300A-n were created, wherein the headlight component 153 can be configured to determine whether the headlight(s) 185A-n are operating in low beam or high beam mode.

Image 1300C depicts a vehicle 105 operating with headlights 185 at full beam, as is apparent between the degree of light beams 186A-n depicted in image 1300C compared to image 1300A. Image 1300D is a digital mapping 149A-n of image 1300C whereby the digital mapping has extracted the portions of the image 1300C pertaining to light beams 186A-n emitted by headlights 185A-n. As shown, the area of light 1310 in image 1300D is significantly larger than the area of light 1310 in image 1300B. In a further embodiment, the headlight component 153 can (e.g., in conjunction with cameras/sensors 148A-n, images/data 149A-n, algorithms 164A-n, and suchlike) be configured to extract pixels in images 149A-n having an intensity above a threshold value to enable the light beams 186A-n to be extracted from background light/digital noise, wherein the threshold value can be any arbitrary value). Image 1300E presents the light regions/pixels 1310 associated with the light beams 186A-n being extracted from the light pixels and background/noise pixels presented in image 1300D. Any suitable technology/techniques can be utilized to perform the pixel extraction process, for example, Fourier Transform analysis can be applied. FIG. 14, chart 1410 illustrate a pixel extraction process being undertaken, in accordance with an embodiment. As shown, pixels of varying intensity are included in image 1300D, while those pixels having an intensity above a threshold value are presented in image 1300E enabling a black and white image to be formed. Further, the conversion from image 1300D to 1300E does not require pixels in image 1300D to be only black and white, coloured pixels can be present in image 1300D (e.g., yellow pixel(s), blue pixel(s), red pixel(s), and suchlike), whereby the intensity of the pixel (and surrounding pixels) is measured and those coloured pixels having an intensity above the threshold are presented in image 1300E. As further shown, a plot/histogram 1410 can be generated and presents the distribution of intensity of a pixel (x axis) versus the number of pixels having a particular intensity (y axis). As shown in 1410, the distribution has a greater number of pixels having a lower intensity (e.g., region L, 2000-8000 pixels with an intensity of approx. 0.1 to 0.25) than a higher intensity (e.g., region H having <2000 pixels with an intensity of 0.75 to 0.9). Hence, the headlight component 153 can infer that the light beam 186 captured in images 1300D and 1300E is a low beam. Based on the number of pixels detected at region L versus region H, headlight component 153 can infer that the headlight beam 186 captured in images 1300D and 1300E is from a headlight 185 having a low beam operation or a high beam operation.

The term “low beam” generally relates herein to a light beam 186 emitted by a headlight 185 such that the light beam 186 projects to illuminate the road 315 approximately 100 ft (40 m) in front of a vehicle (e.g., vehicle 102, vehicle 105). The term “high beam” generally relates herein to a light beam 186 emitted by a headlight 185 such that the light beam 186 projects to illuminate the road 315 and surroundings approximately 300 ft (100 m) in front of a vehicle (e.g., vehicle 102, vehicle 105). Selection of which beam function is used can be controlled both manually (e.g., by driver 104) and automatically (e.g., by a computer system and light detector(s) onboard a vehicle).

Turning to FIG. 15, FIG. 15, schematic 1500 illustrates light analysis being performed to determine whether a light source is stationary or moving, in accordance with an embodiment. The headlight component 153 can perform analysis (e.g., in conjunction with cameras/sensors 148A-n, images/data 149A-n, algorithms 164A-n, and suchlike) to determine whether a light source is stationary or moving. As shown in FIG. 15, a street light 1510 can be located at the side of road 315. As vehicle 102 moves towards street light 1510, an onboard distance sensor 148 can measure the distance from vehicle 102 to the street light 1510 and as vehicle 102 moves towards the street light 1510, from repeated measurements by the distance sensor 148, the headlight component 153 can determine that the street light 1510 is not moving, and is stationary/fixed in position. For example, for a stationary object, the object will advance towards vehicle 102 according to the velocity of vehicle 102, e.g., vehicle 102 is driving at 50 km/h the distance SD between vehicle 102 and the street light 1510 will reduce at a rate of 14 m/s. Accordingly, any pixels in an image 149 captured of the scene emanating from the street light 1510 (or a sign, traffic lights, etc.) can be ignored.

As further shown in FIG. 15, a vehicle 105 (e.g., a truck) is driving along road 315 towards vehicle 102, with a headlight beam 186 directed towards and impinging on vehicle 102. The onboard distance sensor 148 can be further configured to determine the respective distance (e.g., versus time) of the vehicle 105 to vehicle 102, from which a velocity of vehicle 105 can be determined. In the event of the vehicle 102 and vehicle 105 are moving towards each other, the distance MD will reduce based on velocity of vehicle 102+velocity of vehicle 105. For example, vehicle 102 is driving at 50 km/h and vehicle 105 is driving at 50 km/h, distance MD reduces at a rate of 30 m/s. Accordingly, headlight component 153 can determine that street light 1510 is stationary while vehicle 105 is moving.

As mentioned, issues regarding glare can equally pertain to light whether it be sunbeams 103A from sun 103 or light beams 186 from headlights 185, with a driver 104 having to deal with them equally and often in the same manner, e.g., use of an onboard sun-visor, blinking, squinting, averting gaze, and such like. Accordingly, issues pertaining to driver 104 being blinded by sunbeams 103A also apply to driver 104 operating a vehicle at night, in a tunnel, etc., with regard to not being able to discern other entities such as other vehicles 105A-n, pedestrian(s) 106A-n, cyclist(s) 107A-n, animal(s) 108A-n.

Based on the foregoing, the following series of figures present various example scenarios of operation and one or more operations/actions that vehicle 102 can perform in such scenarios to reduce/mitigate likelihood of an accident/collision occurring involving vehicle 102 and/or vehicle 105 when operating with potential glare from a headlight beams 186.

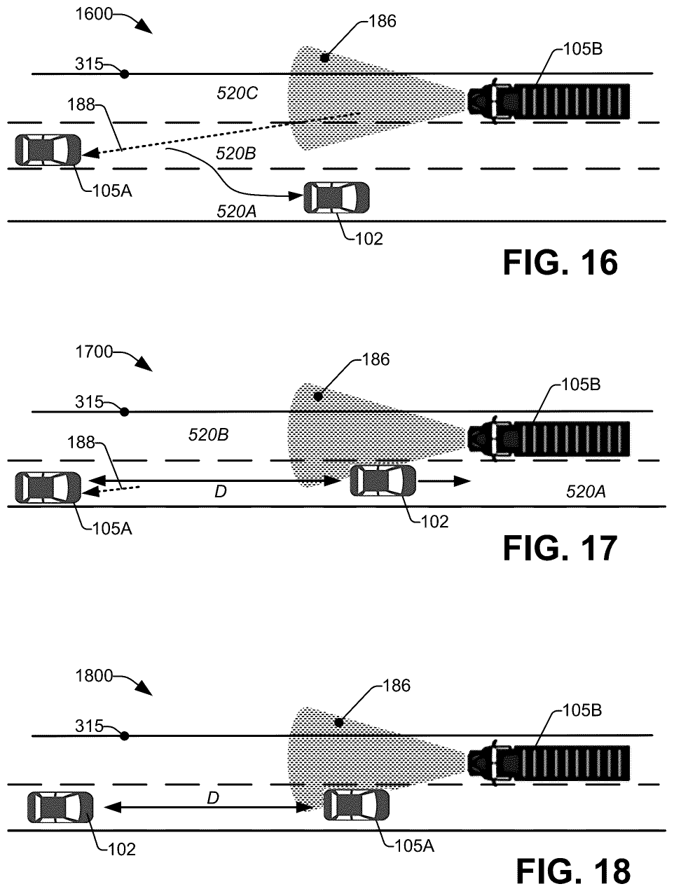

FIG. 16, schematic 1600 presents an example scenario of a first vehicle operating to prevent an accident involving a second vehicle, according to one or more embodiments. In an embodiment, vehicle detection component 163, onboard vehicle 102, determines vehicle 105A is advancing upon vehicle 102, with both vehicles 105A and 102 driving (e.g., in lane 520B) towards vehicle 105B (e.g., in lane 520C). Vehicle detection component 163 has detected (e.g., via any of cameras/sensors 148A-n, images/data 149A-n, vehicle database 180, communications component 170) vehicle 105A is being operated in a partially autonomous or non-autonomous manner. Accordingly, AAC 165 is configured to monitor operation of vehicle 105A. Headlight component 153 (e.g., via cameras/sensors 148A-n and images/data 149A-n) determines that vehicle 105B is positioned such that glare can occur, with headlight beams 186A incident upon driver 104's face who is driving vehicle 105A, and further, the vision component 156 can be configured to obtain information (e.g., via cameras/sensors 148A-n and images/data 149A-n) regarding whether the driver 104 of vehicle 105A is susceptible to/experiencing glare effects. In the example scenario presented, vehicle 102 may be travelling with a slower velocity than vehicle 105A, and owing to glare effects, driver 104 may not be aware of the presence of vehicle 102. In response to making a determination that YES, driver 104 is operating vehicle 105A while being potentially influenced by glare, vehicle 102 can take action to avoid being in a collision (e.g., rear-ended) with vehicle 105A. AAC 165 can instruct (e.g., via a notification 166A-n) road component 160 to make a determination whether it is safe for vehicle 102 to change lanes (e.g., from lane 520B to 520A), and based on receiving a notification 166A-n that YES, it is safe to change lanes, AAC 165 can generate and transmit a notification 166A-n to the navigation component 141 instructing navigation component 141 to change lanes of operation of vehicle 102, thereby opening up lane 520B for vehicle 105A to drive by vehicle 102. In response to receiving the notification 166A-n, the navigation component 141 steers vehicle 102 into lane 520C and out of the path of vehicle 105A.

FIG. 17, schematic 1700 presents an example scenario of a first vehicle operating to prevent an accident involving a second vehicle, according to one or more embodiments. The scenario presented in FIG. 17 is similar to that presented in FIG. 16, however, unlike the scenario presented in FIG. 16, with FIG. 17 there is no adjacent lane for vehicle 102 to navigate to. In an embodiment, vehicle detection component 163, onboard vehicle 102, determines vehicle 105A is advancing upon vehicle 102, with both vehicles 105A and 102 driving (e.g., in lane 520A) towards vehicle 105B (e.g., in lane 520B). Vehicle detection component 163 has detected (e.g., via any of cameras/sensors 148A-n, images/data 149A-n, vehicle database 180, communications component 170) vehicle 105A is being operated in a partially autonomous or non-autonomous manner. Accordingly, AAC 165 is configured to monitor operation of vehicle 105A. Headlight component 153 determines that vehicle 105B is positioned such that glare can occur, with headlight beams 186 incident upon driver 104's face who is driving vehicle 105A, and further, the vision component 156 can be configured to obtain information (e.g., via cameras/sensors 148A-n and images/data 149A-n) regarding whether the driver 104 of vehicle 105A is susceptible to/experiencing glare effects. In the example scenario presented, vehicle 102 may be travelling with a slower velocity than vehicle 105A, and owing to glare effects, driver 104 may not be aware of the presence of vehicle 102. In an embodiment, vehicle 102 may be travelling with a velocity that is below the speed limit for road 315. In response to making a determination that YES, driver 104 is operating vehicle 105A while being potentially influenced by glare, vehicle 102 can take action to avoid being in a collision (e.g., rear-ended) with vehicle 105A. AAC 165 can generate and transmit a notification 166A-n to the navigation component 141/brake component 145 instructing navigation component 141/brake component 145 to increase the velocity of vehicle 102 (in accordance with the speed limit of road 315) to increase the distance D between vehicle 102 and vehicle 105A.

FIG. 18, schematic 1800 presents an example scenario of a first vehicle operating to prevent being involved in an accident involving a second vehicle, according to one or more embodiments. The scenario presented in FIG. 18 is similar to those presented in FIGS. 16 and 17, however, unlike the scenarios presented in FIGS. 16 and 17, with vehicle 105A being driven ahead of vehicle 102, vision component 156 is unable to detect whether driver 104 is being affected by glare. Based on how headlight beams 186A-n impinge on vehicle 105A (e.g., headlight beam 186 is a high beam directly impinging on vehicle 105A) headlight component 153 can infer that the driver 104 is affected by glare. In an embodiment, vehicle detection component 163, onboard vehicle 102, determines vehicle 105A is ahead of vehicle 102 and advancing towards vehicle 105B. Vehicle detection component 163 has detected (e.g., via any of cameras/sensors 148A-n, images/data 149A-n, vehicle database 180, communications component 170) vehicle 105A is being operated in a partially autonomous or non-autonomous manner. Accordingly, AAC 165 is configured to monitor operation of vehicle 105A. Headlight component 153 determines that vehicle 105B is positioned such that glare can occur, with headlight beams 186A-n incident upon driver 104's face who is driving vehicle 105A, and further, the vision component 156 can be configured to obtain information (e.g., via cameras/sensors 148A-n and images/data 149A-n) regarding whether the driver 104 of vehicle 105A is susceptible to/experiencing glare effects. In response to making a determination that YES, driver 104 is operating vehicle 105A while being potentially influenced by glare, vehicle 102 can take action to avoid being involved in an accident that involved vehicle 105A. AAC 165 can generate and transmit a notification 166A-n to the navigation component 141/brake component 145 instructing navigation component 141/brake component 145 to increase the distance D between vehicle 102 and vehicle 105A.

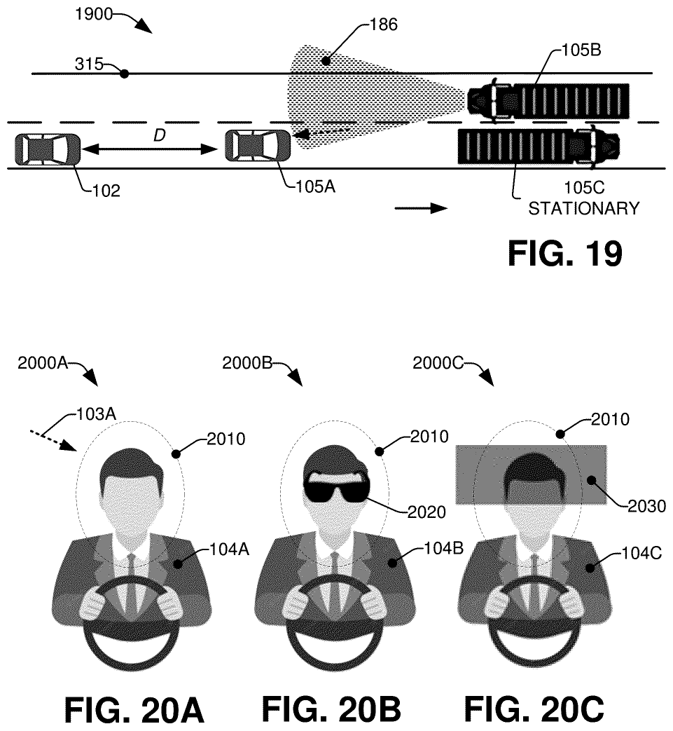

FIG. 19, schematic 1900 presents an example scenario of a first vehicle operating to prevent being involved in an accident involving a second vehicle, according to one or more embodiments. The example scenario presented in FIG. 19 involves vehicle 102 and vehicle 105A advancing towards vehicle 105C, where vehicle 105C is parked in the road 315 (e.g., vehicle 105C has broken down). Further, vehicle 105B is driving towards vehicle 105A and vehicle 102, with headlight beams 186A-n incident upon 105A. Similar to the scenario presented in FIG. 18 with vehicle 105A being driven ahead of vehicle 102, vision component 156 is unable to detect whether driver 104 is being affected by glare. Based on how headlight beams 186 impinge on vehicle 105A (e.g., headlight beam 186 is high beam directly impinging on vehicle 105A) headlight component 153 can infer that the driver 104 is affected by glare. In an embodiment, vehicle detection component 163, onboard vehicle 102, determines vehicle 105A is ahead of vehicle 102 and advancing towards vehicles 105B and 105C. Vehicle detection component 163 has detected (e.g., via any of cameras/sensors 148A-n, images/data 149A-n, vehicle database 180, communications component 170) vehicle 105A is being operated in a partially autonomous or non-autonomous manner. Accordingly, AAC 165 is configured to monitor operation of vehicle 105A. Headlight component 153 determines that vehicle 105B is positioned such that glare can occur, with headlight beams 186A incident upon driver 104's face who is driving vehicle 105A, and further, the vision component 156 can be configured to obtain information (e.g., via cameras/sensors 148A-n and images/data 149A-n) regarding whether the driver 104 of vehicle 105A is susceptible to/experiencing glare effects. In response to making a determination that YES, driver 104 is operating vehicle 105A while being potentially influenced by glare and hence may not be aware of stopped vehicle 105C, AAC 165 can take action to avoid being involved in an accident that involves vehicle 105A. AAC 165 can generate and transmit a notification 166A-n to the navigation component 141/brake component 145 instructing navigation component 141/brake component 145 to increase the distance D between vehicle 102 to vehicle 105A.

Returning to FIG. 3, schematic 300, in an embodiment, while vehicle 102 is navigating road 315, the road component 160 and the conditions component 154 can operate to determine and record the presence of the shadows 320A-n and sunlit regions 330A-n, including the time at which vehicle 102 was encountering the respective shadows 320A-n and sunlit regions 330A-n. For example, at times T1 and T3 the conditions component 154 determined that vehicle 102 was operating in a shaded region of road 315 while at times T2 and T4 the conditions component 154 determined vehicle 102 was operating in a sunlit region 330A-n of road surface 315. As previously mentioned, the vehicle detection component 163 can determine a velocity of vehicle 105 and based thereon can be further configured to predict when vehicle 105 will also be driving in the respective shaded regions 320A-n and sunlit regions 330A-n. The pertinent information can be stored (e.g., in memory 114), whereby the AAC 165 can utilize the shadow 320A-n and sunlit 330A-n information to assist in monitoring operation of vehicle 105 as it navigates road 315 and the likelihood of driver 104 being affected by glare when driving in the sunlit regions 330A-n. In an embodiment, when the amount of unbroken shade 320A-n extends for a considerable distance, e.g., driving in a metropolitan area/city, the operation of AAC 165 can be curtailed as driver 104 will not be affected by glare. In another embodiment, the AAC 165 can be configured to determine whether AAC 165 should be monitoring operation of vehicle 105A-n with regard to glare as a function of how intermittent the shadow regions 320A-n are with the sunlit regions 330A-n are.

Turning to FIGS. 20A-C, images 2000A-C illustrate various example scenarios regarding determination of whether a driver is affected by glare, in accordance with one or more embodiments. Three example scenarios are presented for a driver 104 operating vehicle 105: FIG. 20A represents the face of driver 104A is fully exposed to sunbeams 103A, FIG. 20B represents a driver 104B wearing sunglasses 2020 to minimize the effect of sunbeams 103A incident on driver 104B's face, and FIG. 20C represents the face of driver 104C being partially protected from sunbeams 103A by use of a sun-visor 2030 located onboard vehicle 105. As previously mentioned, cameras/sensors 148A-n can be configured to detect a presence of one of drivers 104A-n located in/operating vehicle 105 and further obtain imagery (e.g., images 149A-n) of the head region 2010 of the respective driver 104A-n. Vision component 156 (e.g., with algorithms 164A-n) can be configured to analyze the images 149A-n to determine whether the driver 104 may be susceptible to glare, and further, generate and transmit a notification 166A-n to the AAC 165 to enable the AAC 165 to determine whether glare susceptibility/situation exists. In an embodiment, vision component 156 can determine that owing to there being no sunglasses 2020 or shadow by sun-visor 2030 present on face of driver 104A, driver 104A is susceptible to glare, with notification 166A-n indicating no shade/face exposed and susceptible to glare. In another embodiment, vision component 156 can determine that owing to sunglasses 2020, a sun-visor 2030, or other shade-providing component is being used, drivers 104B and 104C are not overly susceptible to glare, with notification 166A-n indicating glare reduction is in place and the respective driver 104B or 104C is not overly susceptible to glare. Determination of whether a glare reducing object/approach is being utilized can be based on the vision component 156 and algorithms 164A-n determining regions of the driver's face that is being illuminated by the sunbeams 103A or the headlight beams 186, while the other portions of the driver's face are dark (e.g., dark regions at the eyeball region of the face from sunglasses 2020) or in shadow (e.g., from sun-visor 2030). In a further embodiment, the vision component 156 can be further configured to determine whether a driver (e.g., driver 104B) is wearing sunglasses 2020 or the glasses are regular glasses, such that in the event of the latter, the vision component 156 can make a determination that a driver 104 who is only wearing glasses is susceptible to glare, with a notification 166A-n being generated and transmitted accordingly.

In a further embodiment, the vision component 156 can be configured to determine whether a driver 104 is being impacted by glare by virtue of whether the glare is causing the driver 104 to squint through narrowly open eyelids, how wide open the eyelids are (e.g., wide or normal potentially indicates driver 104 is not affected by glare, while squinting, overly frequent blinking does indicate a glare effect(s) is being experienced by the driver 104).

As previously mentioned, the AAC 165 can make a determination of whether a glare effect is being experienced by a driver 104 based on a variety of data generated by respective analysis and notifications 166A-n generated and transmitted to the AAC 165, by any of, in a non-limiting list:
(a) sun component 152 indicates the presence of sunbeams 103A potentially incident upon driver 104's face, (b) headlight component 153 indicates the presence of headlight beams 186 being potentially incident upon driver 104's face, (c) headlight component 153 indicates the headlight beams 186 have an intensity to cause glare, and suchlike;
(b) vision component 156 detects any of (i) no eye protection is worn to reduce intensity of sunbeams 103A or headlight beams 186, (ii) eye protection, such as sunglasses 2020 or a sun-visor 2030 is being utilized to reduce intensity of sunbeams 103A or headlight beams 186, (iii) driver 104 is viewing the road through narrowed eyelids, (iv) driver 104 is blinking excessively, and suchlike;
(c) vehicle detection component 163 detects (i) vehicle 105 is being operated fully autonomously, (ii) vehicle 105 is being operated non-autonomously or partially autonomously, (iii) vehicle 105 is being operated in an erratic manner or a potentially reckless manner given the road conditions, (iv) vehicle 105 is not slowing down even though pedestrians, animals, cyclists, etc., may be in the path of vehicle 105. (v) vehicle 105 is not being driven in a manner responsive to the road conditions, and suchlike; and/or
(d) entity component 158 has detected one or more entities 106A-n, 107A-n, and/or 108A-n, on or near a road 315 and present operation of vehicle 105 indicates there is a likelihood of vehicle 105 colliding with the one or more entities 106A-n, 107A-n, 108A-n, and suchlike.

As previously mentioned, data generated by any of the components, systems, sensors, devices, cameras, etc., can be shared/transmitted to another component, such as each of the components included in GC 150 can generate and share data with the AAC 165 to enable AAC 165 to make an inference as to the likelihood of an accident occurring as a result of a glare effect. As mentioned, based on the inference, the AAC 165 can generate notifications/instructions 166A-n instructing other components to perform a respective operation based on the inference.

As mentioned, AAC 165 can conduct one or more determinations of whether an accident may occur owing to a driver 104 operating a vehicle 105A-n under conditions of glare based on a threshold. The threshold value can be arbitrary and with respective measures/parameters being combined, and further weighted. For example, a threshold value may be set between 0 and 1, with an arbitrary threshold value of 0.8 set for a likelihood of accident, wherein greater than 0.8 indicates an accident involving vehicle 105 being driven by driver 104 experiencing glare is likely, while a value of less than 0.8 indicates there is no risk of an accident occurring. Based on a determination that sunbeams 103A are incident upon vehicle 105, indicator x may be set to 0.5, and further, with a determination that driver 104 is having trouble with glare, x may be increased to 0.85, such that the AAC 165 determines an accident involving vehicle 105 is likely, based on the threshold value of 0.8. In another scenario, based on a determination that sunbeams 103A are incident upon vehicle 105, indicator x may be set to 0.5, and further, with a determination that driver 104 is wearing sunglasses, x may be increased to 0.7, such that the AAC 165 determines an accident involving vehicle 105 is not likely, based on the threshold value of 0.8. In a further scenario, based on a determination that sunbeams 103A are not incident upon vehicle 105, indicator x may be set to 0.1, such that the AAC 165 determines an accident involving vehicle 105 is not likely, based on the threshold value of 0.8.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In this particular embodiment, sun component 152, the headlights component 153, the entity component 158, conditions component 154, vision component 156 road component 160, vehicle detection component 163, accident avoidance component 165, warning component 168, and associated algorithms 364A-n can include machine learning and reasoning techniques and technologies that employ probabilistic and/or statistical-based analysis to prognose or infer an action that a user desires to be automatically performed. The various embodiments presented herein can utilize various machine learning-based schemes for carrying out various aspects thereof. For example, a process for determining (a) a location of sun 103, headlights 185A-n, (b) presence and operation of vehicle 105A-n. (c) whether a driver 104A-n is being affected by glare, (d) the presence of an entity 106A-n, 107A-n, 108A-n, and whether they may be affected by glare, and further, what their next action may be, and suchlike, as previously mentioned herein, can be facilitated via an automatic classifier system and process.

A classifier is a function that maps an input attribute vector, x=(x1, x2, x3, x4, xn), to a class label class (x). The classifier can also output a confidence that the input belongs to a class, that is, f (x)=confidence (class (x)). Such classification can employ a probabilistic and/or statistical-based analysis (e.g., factoring into the analysis utilities and costs) to prognose or infer an action that a user desires to be automatically performed (e.g., determination of a driver 104A-n or an entity 106A-n, 107A-n. 108A-n being affected by glare).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, a glare event (e.g., presence of sun 103, headlights 185A-n, or other bright light) in conjunction with a reaction by any of driver 104A-n, entity 106A-n, 107A-n, 108A-n while being affected by glare, for example.

As described supra, inferences can be made, and operations performed, based on numerous pieces of information. For example, information/data regarding location of sun 103/headlights 185A-n, incidence of sun beams 103A and/or headlight beams 186A-n, respective location and motion of any of driver 104A-n, entity 106A-n, 107A-n, 108A-n, vehicle 102, vehicles 105A-n, etc., as operation of vehicle 102 continues is compiled with information/data generated by the respective components included in, or in communication with, the glare component 150 and the information/data accumulated (e.g., in memory 114) regarding sunbeams 103A, headlight beams 186A-n, responses by driver 104A-n, entity 106A-n, 107A-n, 108A-n, vehicle 102, vehicles 105A-n, and suchlike, enabling analysis determine converging patterns such that inferences can be made regarding sound events and the likely occupant reaction.

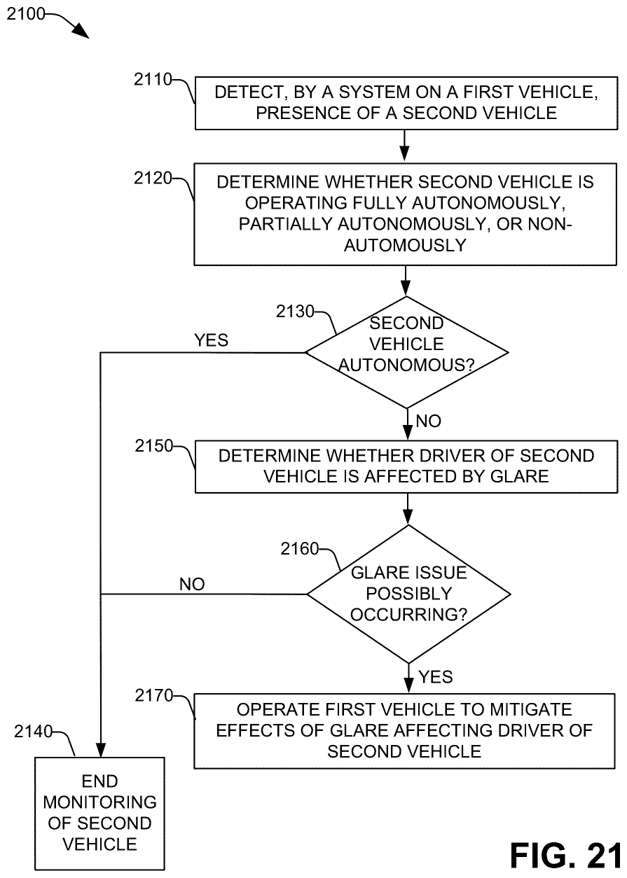

FIG. 21 illustrates a flow diagram 2100 for a computer-implemented methodology for a first vehicle preventing an accident involving a second vehicle and/or another entity, in accordance with at least one embodiment.

At 2110, a first vehicle (e.g., vehicle 102) can detect presence of a second vehicle (e.g., vehicle 105), where both the first vehicle and the second vehicle are operating on a road (e.g., road 315). In an embodiment a vehicle detection component (e.g., vehicle detection component 163) operating on the first vehicle can detect the second vehicle.

At 2120, the first vehicle can be further configured to determine whether the second vehicle is operating autonomously, partially-autonomously, and/or non-autonomously. The vehicle detection component can receive imagery (e.g., digital images 149A-n) from onboard cameras/sensors (e.g., cameras/sensors 148A-n) from which the manufacturer and model of the second vehicle can be identified. Using the manufacturer/model information, the vehicle detection component can be further configured to access a vehicle database 180, for which information can be retrieved regarding whether the particular manufacturer/model supports any of autonomous, partially-autonomous, and/or non-autonomous operation. In another embodiment, the vehicle detection component can communicate with the second vehicle, whereby the vehicle detection component can be configured to request the second vehicle identifies how it is being operated, and based on the response, the vehicle detection component can determine whether the second vehicle is being operated in any of an autonomous, partially-autonomous, and/or non-autonomous manner.

At 2130, in response to a determination by the vehicle detection component that the second vehicle is being operated autonomously, the vehicle detection component can generate and transmit a notification (e.g., a notification 166A-n) to an AAC (e.g., AAC 165) indicating the second vehicle is operating autonomously. The AAC can make a determination that YES, the second vehicle is operating autonomously and glare is not an issue for operation of the second operation, with methodology 2100 advancing to 2140 where AAC can cease monitoring operation of the second vehicle.

At 2130, in response to the second vehicle identifying that second vehicle is operating in at least one of partially-autonomously or non-autonomously, the AAC can make a determination that NO, the second vehicle is not being operated autonomously and the second vehicle may have a driver (e.g., driver 104) operating the second vehicle, wherein, methodology can advance to 2150.

At 2150, a determination (e.g., by sun component 152/headlight component 153 in conjunction with vision component 156, algorithms 164A-n, etc.) can be made as to whether a light source (e.g., sun 103/headlights 185) is illuminating the second vehicle (e.g., sunbeams 103A, headlight beams 186). Further, a determination (e.g., by conditions component 154) can be made as to whether the second vehicle is operating on a road having shade (e.g., shadows 320A-n) or lit (e.g., bright regions 330A-n), whereby operating in the bright regions can give rise to glare. Further, as previously described, the position of the light source (e.g., sun 103/headlights 185) relative to a driver (e.g., driver 104) of the second vehicle can be determined (e.g., by sun component 152/headlight component 153 in conjunction with and of vehicle detection component 163, vision component 156, algorithms 164A-n, etc.) such that are the sunbeams/headlight beams incident upon the driver of the second vehicle? Further, the vision component (e.g., vision component 156 and algorithms 164A-n) can be configured to determine whether the driver is affected by glare, e.g., are they squinting, blinking rapidly, driving erratically, wearing sunglasses (e.g., sunglasses 2020), using a sun visor (e.g., sun visor 2030), etc.

At 2160, in response to the AAC making a determination that NO, the driver of the second vehicle is not affected by glare, methodology 2100 can advance to 2140 where AAC can cease monitoring operation of the second vehicle.

At 2160, in response to the AAC making a determination that YES, the driver of the second vehicle is likely affected by glare, methodology 2100 can advance to 2170 where various components can be utilized to operate the first vehicle to mitigate the effect of glare occurring at the second vehicle. The AAC can instruct various vehicle operation components (e.g., any of navigation component 141, engine component 143, brake component 145, devices component 146) to perform any of reduce the velocity or increase the velocity of the first vehicle to create operational distance between the first vehicle and the second vehicle, stop motion of the first vehicle, change a lane of operation of the first vehicle, operate an onboard horn/audible device to alert the driver of the second vehicle and/or any entities (e.g., any of pedestrians 106A-n, cyclists 107A-n, animals 108A-n) of the presence of the second vehicle and/or the first vehicle, control operation of the second vehicle (e.g., via vehicle-to-vehicle communications), and suchlike.

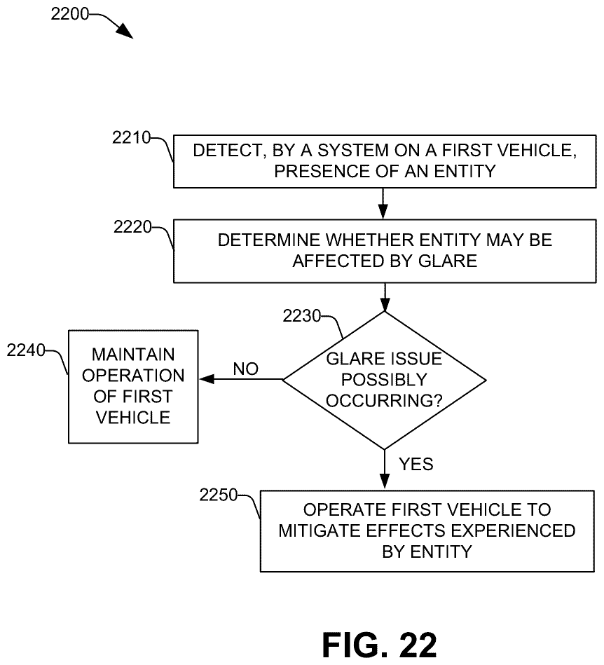

FIG. 22 illustrates a flow diagram 2200 for a computer-implemented methodology for a first vehicle preventing an accident involving an entity located on or by a road, in accordance with at least one embodiment.

At 2210, a first vehicle (e.g., vehicle 102) can detect presence of an entity (e.g., any of a pedestrian/runner 106, a cyclist 107, an animal 108) located on or proximate to a road (e.g., road 315) along which the first vehicle is driving. In an embodiment an entity component (e.g., entity component 158) operating on the first vehicle can be configured to detect the entity.

At 2220, at the first vehicle, a determination (e.g., by sun component 152/headlight component 153 in conjunction with vision component 156, algorithms 164A-n, etc.) can be made as to whether a light source (e.g., sun 103/headlights 185) is illuminating the entity (e.g., by sunbeams 103A, headlight beams 186). Further, a determination (e.g., by conditions component 154) can be made as to whether the entity is located in an area of the road having shade (e.g., shadows 320A-n) or lit (e.g., bright regions 330A-n), whereby being located in the bright regions can give rise to glare (e.g., a crosswalk 550 does not have any shade). Further, as previously described, the position of the light source (e.g., sun 103/headlights 185) relative to the entity can be determined (e.g., by sun component 152/headlight component 153 in conjunction with vision component 156, algorithms 164A-n, etc.) such that are the sunbeams/headlight beams incident upon the entity? Further, the vision component (e.g., vision component 156 and algorithms 164A-n) can be configured to determine whether the entity is affected by glare, e.g., are they squinting, blinking rapidly, driving erratically, wearing sunglasses (e.g., sunglasses 2020), etc. Further, the entity component and the vision component can be configured to determine the age of the entity (e.g., where the entity is a person), e.g., based on posture analysis, face analysis, and suchlike (e.g., by algorithms 164A-n). In an embodiment, the various determinations can be applied to an AAC (e.g., AAC 165) configured to determine whether the entity is having issues with glare.

At 2230, in response to the AAC making a determination that NO, the entity is not affected by glare, methodology 2200 can advance to 2240 where AAC can maintain operation of the first vehicle. For example, without glare issues, a sufficient distance can exist between the entity and the first vehicle that the entity can cross the road without concern of the entity being hit by the first vehicle.

At 2230, in response to the AAC making a determination that YES, the entity is affected by glare, methodology 2200 can advance to 2250 whereby the various components onboard the first vehicle can be utilized to operate the first vehicle to mitigate the effect of the entity experiencing the effect(s) of glare. The AAC can instruct various vehicle operation components (e.g., any of navigation component 141, engine component 143, brake component 145, devices component 146) to perform any of reduce the velocity of/stop the first vehicle to enable sufficient time for the entity to cross the road, change a lane of operation of the first vehicle (e.g., to enable a pedestrian to cross the road, to avoid a cyclist, etc.), operate an onboard horn/audible device to alert/scare the entity, and suchlike.

### Example Applications and Use

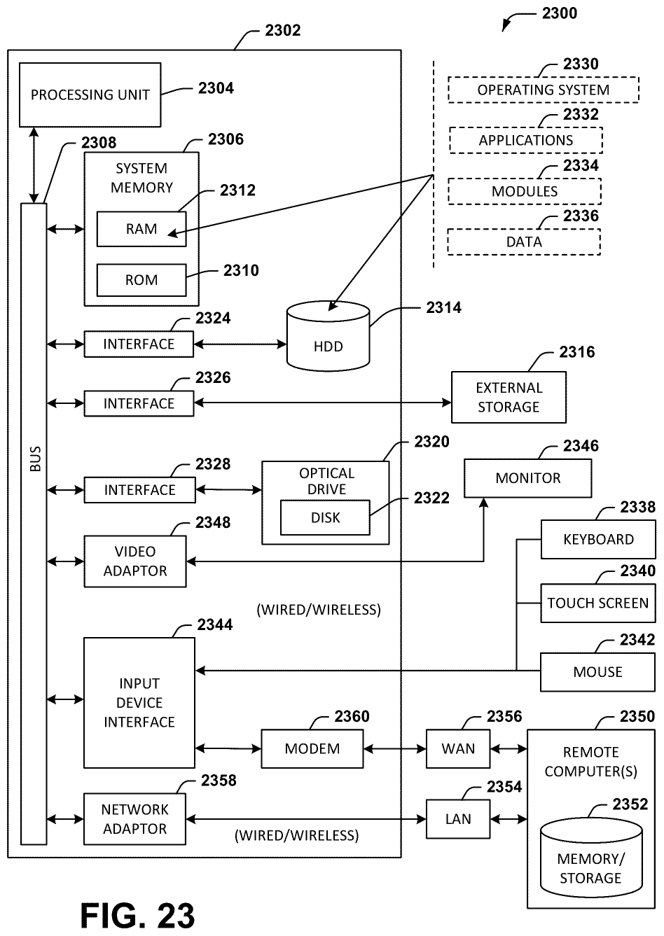

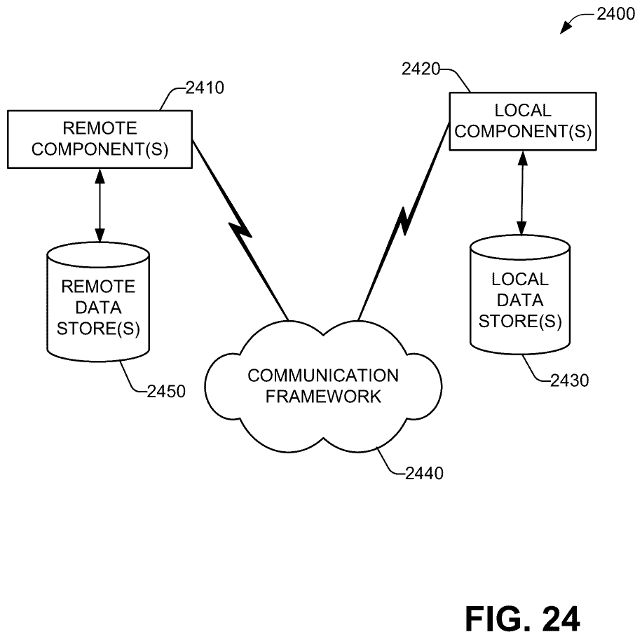

Turning next to FIGS. 23 and 24, a detailed description is provided of additional context for the one or more embodiments described herein with FIGS. 1-22.

In order to provide additional context for various embodiments described herein, FIG. 23 and the following discussion are intended to provide a brief, general description of a suitable computing environment 2300 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 23, the example environment 2300 for implementing various embodiments of the aspects described herein includes a computer 2302, the computer 2302 including a processing unit 2304, a system memory 2306 and a system bus 2308. The system bus 2308 couples system components including, but not limited to, the system memory 2306 to the processing unit 2304. The processing unit 2304 can be any of various commercially available processors and may include a cache memory. Dual microprocessors and other multi-processor architectures can also be employed as the processing unit 2304.

The system bus 2308 can be any of several types of bus structure that can further interconnect to a memory bus (with or without a memory controller), a peripheral bus, and a local bus using any of a variety of commercially available bus architectures. The system memory 2306 includes ROM 2310 and RAM 2312. A basic input/output system (BIOS) can be stored in a non-volatile memory such as ROM, erasable programmable read only memory (EPROM), EEPROM, which BIOS contains the basic routines that help to transfer information between elements within the computer 2302, such as during startup. The RAM 2312 can also include a high-speed RAM such as static RAM for caching data.

The computer 2302 further includes an internal hard disk drive (HDD) 2314 (e.g., EIDE, SATA), one or more external storage devices 2316 (e.g., a magnetic floppy disk drive (FDD) 2316, a memory stick or flash drive reader, a memory card reader, etc.) and an optical disk drive 2320 (e.g., which can read or write from a CD-ROM disc, a DVD, a BD, etc.). While the internal HDD 2314 is illustrated as located within the computer 2302, the internal HDD 2314 can also be configured for external use in a suitable chassis (not shown). Additionally, while not shown in environment 2300, a solid-state drive (SSD) could be used in addition to, or in place of, an HDD 2314. The HDD 2314, external storage device(s) 2316 and optical disk drive 2320 can be connected to the system bus 2308 by an HDD interface 2324, an external storage interface 2326 and an optical drive interface 2328, respectively. The interface 2324 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 2302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2312, including an operating system 2330, one or more application programs 2332, other program modules 2334 and program data 2336. All or portions of the operating system, applications, modules, and/or data can also be cached in the RAM 2312. The systems and methods described herein can be implemented utilizing various commercially available operating systems or combinations of operating systems.

Computer 2302 can optionally comprise emulation technologies. For example, a hypervisor (not shown) or other intermediary can emulate a hardware environment for operating system 2330, and the emulated hardware can optionally be different from the hardware illustrated in FIG. 23. In such an embodiment, operating system 2330 can comprise one virtual machine (VM) of multiple VMs hosted at computer 2302. Furthermore, operating system 2330 can provide runtime environments, such as the Java runtime environment or the .NET framework, for applications 2332. Runtime environments are consistent execution environments that allow applications 2332 to run on any operating system that includes the runtime environment. Similarly, operating system 2330 can support containers, and applications 2332 can be in the form of containers, which are lightweight, standalone, executable packages of software that include, e.g., code, runtime, system tools, system libraries and settings for an application.

Further, computer 2302 can comprise a security module, such as a trusted processing module (TPM). For instance with a TPM, boot components hash next in time boot components, and wait for a match of results to secured values, before loading a next boot component. This process can take place at any layer in the code execution stack of computer 2302, e.g., applied at the application execution level or at the operating system (OS) kernel level, thereby enabling security at any level of code execution.

A user can enter commands and information into the computer 2302 through one or more wired/wireless input devices, e.g., a keyboard 2338, a touch screen 2340, and a pointing device, such as a mouse 2342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2304 through an input device interface 2344 that can be coupled to the system bus 2308, but can be connected by other interfaces, such as a parallel port, an IEEE 1094 serial port, a game port, a USB port, an IR interface, a BLUETOOTH® interface, etc.

A monitor 2346 or other type of display device can be also connected to the system bus 2308 via an interface, such as a video adapter 2348. In addition to the monitor 2346, a computer typically includes other peripheral output devices (not shown), such as speakers, printers, etc.

The computer 2302 can operate in a networked environment using logical connections via wired and/or wireless communications to one or more remote computers, such as a remote computer(s) 2350. The remote computer(s) 2350 can be a workstation, a server computer, a router, a personal computer, portable computer, microprocessor-based entertainment appliance, a peer device or other common network node, and typically includes many or all of the elements described relative to the computer 2302, although, for purposes of brevity, only a memory/storage device 2352 is illustrated. The logical connections depicted include wired/wireless connectivity to a local area network (LAN) 2354 and/or larger networks, e.g., a wide area network (WAN) 2356. Such LAN and WAN networking environments are commonplace in offices and companies, and facilitate enterprise-wide computer networks, such as intranets, all of which can connect to a global communications network, e.g., the internet.

When used in a LAN networking environment, the computer 2302 can be connected to the local network 2354 through a wired and/or wireless communication network interface or adapter 2358. The adapter 2358 can facilitate wired or wireless communication to the LAN 2354, which can also include a wireless access point (AP) disposed thereon for communicating with the adapter 2358 in a wireless mode.

When used in a WAN networking environment, the computer 2302 can include a modem 2360 or can be connected to a communications server on the WAN 2356 via other means for establishing communications over the WAN 2356, such as by way of the internet. The modem 2360, which can be internal or external and a wired or wireless device, can be connected to the system bus 2308 via the input device interface 2344. In a networked environment, program modules depicted relative to the computer 2302 or portions thereof, can be stored in the remote memory/storage device 2352. It will be appreciated that the network connections shown are example and other means of establishing a communications link between the computers can be used.

When used in either a LAN or WAN networking environment, the computer 2302 can access cloud storage systems or other network-based storage systems in addition to, or in place of, external storage devices 2316 as described above. Generally, a connection between the computer 2302 and a cloud storage system can be established over a LAN 2354 or WAN 2356 e.g., by the adapter 2358 or modem 2360, respectively. Upon connecting the computer 2302 to an associated cloud storage system, the external storage interface 2326 can, with the aid of the adapter 2358 and/or modem 2360, manage storage provided by the cloud storage system as it would other types of external storage. For instance, the external storage interface 2326 can be configured to provide access to cloud storage sources as if those sources were physically connected to the computer 2302.

The computer 2302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 24, an illustrative cloud computing environment 2400 is depicted. FIG. 24 is a schematic block diagram of a computing environment 2400 with which the disclosed subject matter can interact. The system 2400 comprises one or more remote component(s) 2410. The remote component(s) 2410 can be hardware and/or software (e.g., threads, processes, computing devices). In some embodiments, remote component(s) 2410 can be a distributed computer system, connected to a local automatic scaling component and/or programs that use the resources of a distributed computer system, via communication framework 2440. Communication framework 2440 can comprise wired network devices, wireless network devices, mobile devices, wearable devices, radio access network devices, gateway devices, femtocell devices, servers, etc.

The system 2400 also comprises one or more local component(s) 2420. The local component(s) 2420 can be hardware and/or software (e.g., threads, processes, computing devices). In some embodiments, local component(s) 2420 can comprise an automatic scaling component and/or programs that communicate/use the remote resources 2410 and 2420, etc., connected to a remotely located distributed computing system via communication framework 2440.

One possible communication between a remote component(s) 2410 and a local component(s) 2420 can be in the form of a data packet adapted to be transmitted between two or more computer processes. Another possible communication between a remote component(s) 2410 and a local component(s) 2420 can be in the form of circuit-switched data adapted to be transmitted between two or more computer processes in radio time slots. The system 2400 comprises a communication framework 2440 that can be employed to facilitate communications between the remote component(s) 2410 and the local component(s) 2420, and can comprise an air interface, e.g., Uu interface of a UMTS network, via a long-term evolution (LTE) network, etc. Remote component(s) 2410 can be operably connected to one or more remote data store(s) 2450, such as a hard drive, solid state drive, SIM card, device memory, etc., that can be employed to store information on the remote component(s) 2410 side of communication framework 2440. Similarly, local component(s) 2420 can be operably connected to one or more local data store(s) 2430, that can be employed to store information on the local component(s) 2420 side of communication framework 2440.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

While not an exhaustive listing, summarizing various embodiments, but not all embodiments, presented herein:

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, located on a first vehicle operating autonomously, comprising:
a memory that stores computer executable components; and
a processor that executes the computer executable components stored in the memory, wherein the computer executable components comprise:
an accident avoidance component configured to adjust operation of the first vehicle based on an entity potentially being affected by glare.

2. The system of claim 1, wherein the glare is caused by sunlight or headlight beams being incident upon the entity.

3. The system of claim 1, wherein the entity is a driver operating a second vehicle and the operation of the first vehicle is adjusted to prevent the second vehicle from colliding with at least one of the first vehicle or another entity.

4. The system of claim 1, further comprising a vehicle detection component configured to:
determine whether a second vehicle is being operated non-autonomously, partially autonomously, or fully autonomously; and
in response to determining the second vehicle is being operated non-autonomously or partially autonomously, generate an instruction to monitor operation of the second vehicle, and transmit the instruction to the accident avoidance component; and
in response to determining the second vehicle is being operated autonomously, generate an instruction to cease monitoring operation of the second vehicle, and transmit the instruction to the accident avoidance component.

5. The system of claim 4, further comprising at least one camera configured to generate an image of the second vehicle; and
wherein the vehicle detection component is further configured to:
identify a manufacturer and model of the second vehicle depicted in the image;
access a vehicle database to determine whether the model of the second vehicle depicted in the image supports any of non-autonomous, partially autonomous, or fully autonomous operation.

6. The system of claim 4, further comprising a first communication system located onboard the first vehicle and configured to:
communicate with a second communication system located onboard the second vehicle; and
generate and transmit an instruction to the second communication system, wherein the instruction requests the second vehicle to identify whether the second vehicle is being operated in non-autonomous, partially autonomous, or fully autonomous manner.

7. The system of claim 1, wherein the adjusted operation of the first vehicle can be at least one of reduce velocity of the first vehicle, stop the first vehicle, increase velocity of the first vehicle, generate an audible alarm at the first vehicle, or change operation from current road lane to an adjacent road lane.

8. The system of claim 1, further comprising a vision component configured to:
in the event of the entity is the driver of a second vehicle, determine the entity is, at least one of, wearing sunglasses, shielding their eyes with an onboard sun-visor, squinting, blinking in an erratic manner, blinking quickly, averting their gaze from sunlight, averting their gaze from a headlight beam, or is driving in an unaffected manner; and
in response to determining the driver of the second vehicle is affected by glare, generate and transmit an instruction to the accident avoidance component instructing the accident avoidance component to maintain monitoring of the driver of the second vehicle; or
in response to determining the driver of the second vehicle is not affected by glare, generate and transmit an instruction to the accident avoidance component instructing the accident avoidance component to discontinue monitoring of the driver of the second vehicle.

9. The system of claim 1, further comprising an entity component configured to:
detect the presence of the entity in a road being navigated by the first vehicle; and
transmit a notification of the detected presence of the entity to the accident avoidance component; and
wherein the accident avoidance component, in response to receiving the detected presence of the entity, is further configured to:
instruct an audible device to generate an audible signal to obtain the entity's attention regarding the presence of at least one of the first vehicle or a second vehicle; or
adjust operation of the first vehicle comprising at least one of:
change lane of operation of the first vehicle from a first lane to an adjacent lane; or
reduce velocity of the first vehicle.

10. The system of claim 1, wherein the entity is a driver of a second vehicle operating proximate to the first vehicle, a pedestrian, a cyclist, or an animal.

11. The system of claim 1, wherein the first vehicle is operating in a fully autonomous manner.

12. A computer-implemented method comprising:
adjusting, by a device comprising a processor located on a first vehicle operating in a fully autonomous manner, operation of the first vehicle based on determining an entity is potentially being affected by glare, wherein operation of the first vehicle is adjusted to reduce probability of the entity being involved in an accident as a result of the glare.

13. The computer-implemented method of claim 12, wherein a source of the glare is:
sunlight incident upon the entity; or
a headlight beam incident upon the entity.

14. The computer-implemented method of claim 12, wherein the entity is one of a driver operating a second vehicle, a pedestrian, a cyclist, or an animal; and
the operation of the first vehicle is adjusted to:
prevent the second vehicle from colliding with at least one of the first vehicle or another other entity; or
prevent the first vehicle from colliding with at least one of the second vehicle or another entity.

15. The computer-implemented method of claim 12, wherein the entity is a second vehicle, and the first vehicle is further configured to:
determine whether the second vehicle is being operated non-autonomously, partially autonomously, or fully autonomously; and
in response to determining the second vehicle is being operated non-autonomously or partially autonomously, maintain monitoring of the second vehicle; or
in response to determining the second vehicle is being operated autonomously, cease monitoring operation of the second vehicle.

16. The computer-implemented method of claim 12, wherein the adjusted operation of the first vehicle can be at least one of reduce velocity of the first vehicle, stop the first vehicle, increase velocity of the first vehicle, generate an audible alarm at the first vehicle, or change operation from current road lane to an adjacent road lane.

17. A computer program product comprising a computer readable storage medium having program instructions embodied therewith, the program instructions executable by a processor to cause the processor to:
adjust operation of a first vehicle in response to detecting an entity being potentially affected by glare, wherein the operation of the first vehicle is adjusted to reduce probability of the entity being involved in an accident as a result of the glare effect.

18. The computer program product of claim 17, wherein a source of the glare is sunlight incident upon the entity or a headlight beam incident upon the entity.

19. The computer program product of claim 17, wherein the program instructions are further executable by the processor to cause the processor to, in the event of the entity is one of a driver operating a second vehicle, a pedestrian, a cyclist, or an animal, adjust the operation of the first vehicle to:
prevent the second vehicle from colliding with at least one of the first vehicle or another other entity; or
prevent the first vehicle from colliding with at least one of the second vehicle or another entity.

20. The computer program product of claim 17, wherein the entity is a second vehicle operating in a partially-autonomous or non-autonomous manner.
